(19) United States
(12) Patent Application Publication
(10) Pub. No.: US 2024/0208868 A1
(43) Pub. Date: Jun. 27, 2024

(54) USE OF NATURAL POZZOLANS IN A METHOD OF MAKING CEMENTITIOUS COMPOSITIONS

(71) Applicant: Partanna Global, Inc., Rancho Santa Fe, CA (US)

(72) Inventor: Sam Franklin MARSHALL, Hidden Hills, CA (US)

(21) Appl. No.: 18/393,093

(22) Filed: Dec. 21, 2023

Related U.S. Application Data
(60) Provisional application No. 63/476,564, filed on Dec. 21, 2022.

(51) Int. Cl. C04B 28/18; C04B 28/08

(52) U.S. Cl. CPC C04B 28/184; C04B 28/08

(57) ABSTRACT

Provided herein, inter alia, are compositions of cementitious products using recycled materials including natural pozzolans, manmade pozzolans, and/or desalinated waste products and seawater, the methods of preparing, and uses thereof.

### BACKGROUND

In 2015, worldwide Portland Cement manufacture contributed approximately 2.8 billion metric tons of carbon dioxide, CO₂, emissions. These emissions equate to about 8% of the global total of CO₂ emissions. The production of Portland clinker, which acts as the binder, is a critical step in making ordinary Portland Cement (OPC). Limestone (CaCO₃) is calcinated at high temperatures in a cement kiln to produce lime (CaO), leading to the release of waste CO₂.

This decarbonation reaction accounts for approximately 50% of the produced CO₂ emissions, with 40% of emissions coming from burning fossil fuels to heat kilns to the high temperatures needed for this calcination process, and 10% of emissions from fuels required to mine and transport the raw materials. Every ton of Portland Cement produced contributes about a ton of CO₂ both directly through the heat of decomposition of calcium carbonate to produce lime and CO₂, and indirectly through burning fossil fuel to heat the calcium carbonate in the kilns.

The cement industry has attempted to reduce emissions over the last several decades. The industry has implemented energy-efficient kilns, lower-emission fuels, and increased clinker substitution. However, these levers cannot meet the necessary 24% cut in cement emissions needed to limit global temperature rise to below 2ºC (3.8° F.) as defined in the Paris Agreement. Technologies such as carbon capture and storage (CSS) and “novel” cements have been explored to achieve this goal. CSS has not reached commercial-scale development due to cost and energy consumption, and it will be challenging to achieve. Hence, alternative cement technology provides the most logical pathway to reduce emissions in the industry. The present embodiments meet this and other needs.

Although the use of natural pozzolans or pozzolans may be recognized as being capable of inclusion in certain hydraulic binders, the use of natural pozzolans in specific formulations is underappreciated. Prior attempts to use natural pozzolan or pozzolan cements without clinker have encountered numerous problems and other shortcomings, including, for example, difficulties in applications related to vertical and other structural build contexts (e.g., cracking, non-hydraulic performance, inability to use with steel and other metals, etc.). The present application relates various formulations that comprise natural pozzolans in combination with other materials to produce alternative curable formulations to clinker based cements such as Portland cement and/or other currently-known mixes (e.g., including mixes that may contain natural pozzolans) that provide reliable and sustainable alternatives for the construction industry and beyond.

### BRIEF SUMMARY

The present application generally relates to an alternative “cement” technology (e.g., a material that sets, hardens, and/or adheres to other materials to bind them to together, for example to make materials such as concrete) technology comprising natural pozzolans or pozzolans that has improved physical properties including the adsorption of CO₂ and the use of seawater or brine sourced from desalinated water from seawater or well water; a waste product that reduces the energy requirements, cost requirements, and environmental impact. According to some embodiments, certain formulations or mixes that are configured to be combined with water (and/or other liquids) to cure and set in order to form materials suitable for construction are disclosed herein. Such mixes may comprise MgO or Mg(OH)₂ and are alternatives to Portland cement, other calcium-containing binder materials and other traditional binder formulations. In some embodiments, such mixes, before being combined with water and/or another liquid (e.g., brine) (herein referred to as “dry” mixes), do not contain Portland cement. As noted herein, under certain circumstances, mixtures that do not comprise Portland cement or any clinker can provide an environmental benefit (e.g., by reducing greenhouse gas emissions).

In an aspect, provided herein is an artificial, stonelike material set by pouring a cementitious mixture, the poured concrete mixture comprising: (a) a natural pozzolan; (b) granulated ground blast furnace slag; and (c) an aqueous solution comprising one or more accelerant.

In an aspect, provided herein is an artificial, stonelike material set by pouring a cementitious mixture, the poured concrete mixture comprising: (a) a natural pozzolan; (b) granulated ground blast furnace slag; (c) an aqueous solution comprising one or more accelerant; and (d) at least one aggregate.

In an aspect, provided herein is an artificial, stonelike material set by pouring a cementitious mixture, the poured concrete mixture comprising: (a) a pozzolan; (b) slag; (c) an aqueous solution (d) one or more accelerant; and (e) optionally at least one aggregate.

In an aspect, provided herein is an artificial, stonelike material formed from a poured cementitious mixture and configured to absorb and retain carbon dioxide, the poured cementitious mixture comprising (a) a natural pozzolan; (b) granulated ground blast furnace slag; (c) an aqueous solution comprising one or more accelerant; and (d) optionally at least one aggregate.

In an aspect, provided herein is a manufacturing process of a negative carbon dioxide-emitting artificial, stonelike material comprising (a) mixing a natural pozzolan in an aqueous solution comprising one or more accelerant, with granulated ground blast furnace slag to form a cementitious mixture; (b) pouring the cementitious mixture into a structural component mold to form a poured cementitious mixture; and then (c) curing the poured cementitious mixture from step (b) in the structural mold to form a negative-carbon dioxide emitting artificial, stonelike material.

In an aspect, provided herein is a manufacturing process of a negative carbon dioxide-emitting artificial, stonelike material comprising (a) mixing a pozzolan with one or more accelerant and MgO, Mg(OH)₂, or other reactant, and/or slag to form a dry cementitious mixture; (b) combining the dry cementitious mixture with an aqueous solution to form a cementitious mixture; and then (c) curing the cementitious mixture from step (b) to form a negative-carbon dioxide emitting artificial, stonelike material.

In embodiments, the aqueous solution is seawater. In embodiments, the aqueous solution is non-potable water. In embodiments, the aqueous solution is brine. In embodiments, the aqueous solution is concentrated desalination brine. In embodiments, the aqueous mixture is water, for example well water. In embodiments, the well is a brackish well. In embodiments, the aqueous solution is purified water. In embodiments, the brine or seawater comprises accelerants. In embodiments, one or more additional accelerants is added to the mixture (e.g., to the dry mix and/or aqueous solution), for example if the brine or seawater does not contain the needed accelerant(s). A benefit of the present technology can include using the brine as is, e.g. without the need to filter, treat, evaporate or modify the brine. Without being bound by theory, it is expected that the other components of brine will not affect the performance of the mixture(s) described herein. Another benefit of the present technology, as a result, is that it does not require the use of fresh (e.g., drinking) water.

As used herein, reactants may be from any source. For example, Mg(OH)₂ may be from any source. In embodiments, the Mg(OH)₂ is from brucite.

In an aspect, provided herein is an artificial, stonelike material set by pouring a cementitious mixture, the poured concrete mixture comprising: (a) a pozzolan; (b) slag; (c) one or more accelerant and (d) an aqueous solution. In embodiments, the pozzolan is a natural pozzolan. In embodiments, the pozzolan is a manmade pozzolan.

In an aspect, provided herein is an artificial, stonelike material set by pouring a cementitious mixture, the poured concrete mixture comprising: (a) a pozzolan; (b) slag; (c) an aqueous solution; (d) one or more accelerant; and (e) at least one aggregate.

In an aspect, provided herein is an artificial, stonelike material formed from a poured cementitious mixture and configured to absorb and retain carbon dioxide, the poured cementitious mixture comprising (a) a pozzolan; (b) slag; (c) an aqueous solution; (d) one or more accelerant; and (e) optionally at least one aggregate.

In an aspect, provided herein is a manufacturing process of a negative carbon dioxide-emitting artificial, stonelike material comprising (a) mixing a pozzolan in an aqueous solution with one or more accelerant and slag to form a cementitious mixture; (b) pouring the cementitious mixture to form a poured cementitious mixture; and then (c) curing the poured cementitious mixture from step (b) to form a negative-carbon dioxide emitting artificial, stonelike material. In embodiments, the cementitious mixture is poured into a mold. In embodiments, the cementitious mixture is poured into a structural component mold.

In an aspect, provided herein is an artificial, stonelike material set by pouring a cementitious mixture, the poured cementitious mixture comprising: (a) a pozzolan; (b) MgO; (c) an aqueous solution; (d) one or more accelerant; and, (e) optionally at least one aggregate.

In an aspect, provided herein is an artificial, stonelike material set by pouring a cementitious mixture, the poured cementitious mixture comprising: (a) a pozzolan; (b) Mg(OH)₂; (c) an aqueous solution; (d) one or more accelerant; and, (e) optionally at least one aggregate.

In an aspect, provided herein is an artificial, stonelike material set by pouring a cementitious mixture, the poured cementitious mixture comprising: (a) a natural pozzolan; (b) a manmade pozzolan; (c) an aqueous solution; and (d) one or more accelerant. In embodiments, the poured cementitious mixture includes (e) at least one aggregate.

According to some embodiments, any of the curable mixes and formulations disclosed herein can include four different components. A curable mix or formulation can comprise (i) reactant, (ii) natural pozzolan(s) or pozzolan(s), (iii) an accelerant, and (iv) fillers and/or other additives. Such mixes and formulations can be combined with water and/or other liquids and allowed to cure, thereby creating a cured final product (e.g., structure, slab, etc.). According to some embodiments, the curable mix or formulation can include equal or substantially equal portions (by weight of the dry mix) of reactant and natural pozzolan(s) and/or pozzolan(s). For any of the mix or formulation embodiments disclosed herein, the proportions of reactant and natural pozzolan(s) and/or pozzolan(s) in the formulation (e.g., the dry formulation before any water and/or other liquid is added) can be relatively equal to one another. For example, the proportion of the natural pozzolan(s) and/or pozzolan(s) by percentage of weight in the dry mix or formulation is 20% to 180% (e.g., 20%-180%, 30%-170%, 40%-160%, 50%-150%, 60%-140%, 70%-130%, 80%-120%, 90%-110%, 95%-105%, 98%-102%, 99%-101%, values between the foregoing ranges, etc.) of the proportion of reactant by percentage of weight in the dry mix or formulation.

In an aspect, provided herein is an artificial, stonelike material set by pouring a cementitious mixture, the poured concrete mixture comprising: (a) a natural pozzolan or pozzolan (pozzolan); (b) a reactant; and (c) an aqueous solution comprising one or more accelerant, (d) at least one aggregate.

In aspects, a curable mixture configured to set in the presence of water comprises a reactant, a primary natural pozzolan(s) or pozzolan(s), wherein a proportion by weight of the pozzolan(s) is 80% to 120% of a proportion of reactant(s) by weight of the mixture, and at least one accelerant, wherein the at least one accelerant comprises magnesium chloride in the form of MgCl₂·6H₂O or magnesium nitrate in the form of Mg(NO₃)₂·6H₂O.

### DETAILED DESCRIPTION

The present embodiments provide an artificial, stonelike material set by pouring a cementitious mixture, the poured cementitious mixture comprising: (a) a natural pozzolan; (b) a manmade pozzolan, e.g. granulated ground blast furnace slag; (c) an aqueous solution comprising one or more accelerant; (d) and optionally at least one aggregate. In addition, the present embodiments provide an artificial, stonelike material set by pouring a cementitious mixture, the poured cementitious mixture comprising: (a) a pozzolan; (b) slag, MgO, or Mg(OH)₂; (c) an aqueous solution; (d) one or more accelerant; and (e) optionally at least one aggregate. In addition, the present embodiments provide an artificial, stonelike material set by pouring a cementitious mixture, the poured cementitious mixture comprising: (a) a natural pozzolan; (b) a manmade pozzolan; (c) MgO, or Mg(OH)₂; (d) an aqueous solution; (e) one or more accelerant; and (f) optionally at least one aggregate. In embodiments, the poured cementitious mixture includes at least one aggregate.

Conventionally, concrete is a mixture of paste and aggregates, or rocks. The paste, composed of a cementitious material and water, coats the surface of the fine and coarse aggregates. Through a chemical reaction called hydration, the paste hardens and gains strength to form the rock-like mass known as concrete. Concrete can be suitable for building skyscrapers, bridges, sidewalks and superhighways, houses and dams.

The cementitious material of conventional forms of concrete include Portland Cement. Portland Cement is a fine powder, produced by heating limestone (CaCO₃) and clay minerals in a kiln to form clinker (CaO), grinding the clinker, and adding 2% to 3% of gypsum. Several types of Portland Cement are available including ordinary Portland Cement (OPC), which is grey, and white Portland Cement. The low cost and widespread availability of the limestone, shales, and other naturally occurring materials used in Portland Cement make it one of the lowest-cost materials widely used over the last century. However, it is one of the construction industry's largest causes of climate-changing carbon dioxide emissions.

The manufacture of Portland Cement can cause environmental impacts at all stages of the process. These include emissions of airborne pollution in the form of dust, particulate emissions, gases; release of carbon dioxide from the raw materials during manufacture, and damage to countryside from quarrying.

The present application is directed to the unexpected benefits of using natural pozzolans, including basalt and/or volcanic ash, as an alternative to other cement technologies. For example, natural pozzolans avoid problems associated with the depletion and heating/smelting of high-grade ores in land-based mining and is instead sourced from existing natural sources. Further, the present application contemplates combining the use of natural pozzolans and seawater or recycled waste brine to produce the contemplated cementitious products. Thus, using natural pozzolans from natural resources avoids the problem of sourcing large quantities of chemical compounds needed for producing cementitious products thereby further offsetting the carbon-dioxide and energy requirements. In embodiments, pozzolans are used, for example manmade pozzolans. In embodiments, the pozzolans include volcanic ash. In embodiments, basalt is treated with an acid prior to use. For example, basalt may be treated with acid to convert and isolate minerals. In embodiments, a mineral acid is used. In embodiments, the acid is hydrochloric acid, nitric acid, phosphoric acid, sulfuric acid, boric acid, hydrofluoric acid, hydrobromic acid, perchloric acid, or hydroiodic acid. In embodiments, the acid is HCl. In embodiments, basalt is not treated with an acid.

Additional unexpected benefits of the technology described herein include: increased resistance to sulfate attack and improved suitability for marine use and coral substrate. In addition, the dry material (e.g., pozzolans, MgO, Mg(OH)₂, slag, and/or other components) can be added directly to sea water (e.g., sea bed) as part of the hydration process. The technology described herein further reduces or substantially eliminates CO₂ emissions from making and using Portland cement, while also removing CO₂ from the atmosphere.

### I. Definitions

Before the present invention is further described, it is to be understood that this invention is not strictly limited to particular embodiments described, as such may of course vary. It is also to be understood that the terminology used herein is for the purpose of describing particular embodiments only, and is not intended to be limiting, since the scope of the present invention will be limited only by the claims.

It must be noted that as used herein and in the appended claims, the singular forms “a,” “an,” and “the” include plural referents unless the context clearly dictates otherwise. It should further be understood that as used herein, the term “a” entity or “an” entity refers to one or more of that entity. For example, a nucleic acid molecule refers to one or more nucleic acid molecules. As such, the terms “a”, “an”, “one or more” and “at least one” can be used interchangeably. Similarly, the terms “comprising”, “including” and “having” can be used interchangeably.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described. All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates, which may need to be independently confirmed.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination. All combinations of the embodiments are specifically embraced by the present invention and are disclosed herein just as if each and every combination was individually and explicitly disclosed. In addition, all sub-combinations are also specifically embraced by the present invention and are disclosed herein just as if each and every such sub-combination was individually and explicitly disclosed herein.

It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As used herein, the term “about” means a range of values including the specified value, which a person of ordinary skill in the art would consider reasonably similar to the specified value. In embodiments, about means within a standard deviation using measurements generally acceptable in the art. In embodiments, about means a range extending to +/−10% of the specified value. In embodiments, about means the specified value.

As used herein, the term “accelerant” is used in accordance with its plain ordinary meaning and refers a substance that improves the chemical reaction and affords a higher strength material. In embodiments, accelerants contemplated in the present application include, but are not limited to, sulfates, nitrates, phosphates and chloride. The amount of accelerant added may vary depending on various factors. For example, more accelerant may be added to large amounts of material (i.e., high mass). In addition, the lower the ambient temperature, the more accelerant may be used. The amount of accelerant used will vary depending on the amount of pozzolan, MgO or Mg(OH)₂ used. The amount of accelerant used will vary depending on the ratio of pozzolan, MgO or Mg(OH)₂ used. The amount of accelerant used will vary based on the aqueous solution (e.g. water, non-potable water, brackish water, brine, concentrated brine, seawater) used.

As used herein, the term “aggregates” or “aggregate” is used in accordance with its plain ordinary meaning and refers to inert granular materials such as sand, gravel, lightweight aggregate, or crushed stone whether normal weight and/or lightweight that, along with cementitious materials and other optional raw materials such as pigment and/or admixtures, are used in concrete. Further, the term “aggregates” as used herein can include ASTM International C 33 fine aggregates, ASTM International C 33 coarse aggregates, and other particulate materials mixed into a concrete mixture. The aggregate can be processed: crushed, screened, and washed to obtain proper cleanliness and gradation. In some cases, a beneficiation process such as jigging or heavy media separation can be used to upgrade the quality. Once processed, the aggregates can be handled and stored to minimize segregation and degradation and prevent contamination and to also protect from the weather as well as to allow to drain away and/or evaporate moisture. Aggregates, from different sources, or produced by different methods, may differ considerably in particle shape, size and texture. Shape of the aggregates of the present disclosure may be cubical and reasonably regular, essentially rounded, angular, or irregular. Surface texture may range from relatively smooth with small, exposed pores to irregular with small to large, exposed pores. Particle shape and surface texture of both fine and coarse aggregates may influence proportioning of mixtures in such factors as workability, pumpability, fine-to-coarse aggregate ratio, and water requirement.

As used herein, the term “brine” is used in accordance with its plain ordinary meaning, and refers to a high concentration of salt in water. In embodiments, the concentration ranges from about 3 g of salt per liter of water to 26 g of salt per liter of water. In embodiments, the salt concentration of brine exceeds that of natural seawater. In embodiments, the salt concentration of brine is at least 101% greater than the salt concentration of natural seawater. In embodiments, the salt concentration of brine ranges from about 101% greater than the salt concentration of natural seawater to about 1000% greater than the salt concentration of natural seawater. In embodiments, brine is also referred to as desalination brine effluent. In embodiments, brine may include, but is not limited to, trace metals such as iron, nickel, chromium, and molybdenum. In embodiments, the brine is not processed. In embodiments, the brine is minimally processed. In embodiments, the brine is highly concentrated. In embodiments, the brine contains one or more reactants. In embodiments, the brine contains at least 75% (by weight) of one or more reactants. In embodiments, the brine is supplemented with one or more reactants.

As used herein, the term “cement” is used in accordance with its plain ordinary meaning and refers to powdery substance made for use in making mortar or concrete. For example, cement can be a material that sets, hardens, and/or adheres to other materials to bind them to together, for example to make materials such as concrete. In embodiments, concrete is a mineral binder free of any organic compounds. In embodiments, the present application contemplates a Portland-cement free product. Some embodiments contemplate a reduced Portland Cement containing material with less than 90%, 80%, 70%, 60%, 50%, 40%, 30%, 25%, 20%, 15%, 10%, or 5% of Portland Cement; or any sub value or subrange between 0% and 90%. In embodiments, Portland Cement comprises calcium, silicon, aluminum, and iron. In embodiments, Portland Cement comprises CaO, CaCO₃, SiO₂, Al₂O₃, Fe₂O₃, and CaSO₄·H₂O. In embodiments, cement may be characterized as non-hydraulic or hydraulic cement. It should further be understood that “cementitious” can mean a material, including a material according the embodiments described herein that has one or more of the characteristics or features of cement. In some embodiments, the mixture does not comprise Portland cement.

As used herein, the term “concrete” is used in accordance with its plain ordinary meaning and refers to an artificial, stonelike material used for various structural purposes, made by mixing cement and various aggregates, as sand, pebbles, gravel, or shale, with water and allowing the mixture to harden. In embodiments, the term “stonelike” refers to a material that visually, functionally and/or characteristically resembles stone, including when its hardened state. In embodiments, “concrete-replacement material” is interchangeably used with “artificial, stonelike material” throughout.

As used herein, the term “artificial, stonelike material” refers to a cementitious material used for various structural purposes or non-structural purposes (such as a slab, panel, paver or tile), made by mixing a cement alternative as contemplated herein and various aggregates, as sand, pebbles, gravel, lightweight aggregate, or shale, with water and allowing the mixture to harden. In embodiments, the term “stonelike” refers to a material that visually resembles stone. In embodiments, “concrete-replacement material” is interchangeably used with “artificial, stonelike material” throughout.

As used herein, the term “desalination” is used in accordance with its plain ordinary meaning and refers to the process of removing salts or other minerals and contaminants from seawater, brackish water, well water, and wastewater effluent and it is an increasingly common solution to obtain fresh water for human consumption and for domestic/industrial utilization.

As used herein, the phrase “desalination waste water” refers to reject brine from desalination. In embodiments, the process of removing salt from seawater to afford freshwater produces a highly concentrated brine as a by-product. The by-product is usually disposed of by discharging it back into the sea, a process that requires costly pumping systems and that must be managed carefully to prevent damage to marine ecosystems. This process, if not managed properly, disturbs the local water and sediment by introducing a multi-component waste and increasing temperature, which also endangers the marine organisms due to the residual chemicals mixed into the brine from the pre-treatment process.

As used herein, the term “freshwater” refers to water with a low dissolved salt concentration. In embodiments, freshwater does not include seawater and brackish water. In embodiments, freshwater may include, but is not limited to, frozen and meltwater in ice sheets, ice caps, glaciers, snowfields and icebergs, natural precipitation (e.g., rainfall, snowfall, hail, sleet). In embodiments, the salt concentration is less than 5%, less than 4%, less than 3%, less than 2%, and less than 1%, including sub-values in-between.

As used herein, the term “non-hydraulic cement” is used in accordance with its plain ordinary meaning and refers to cement that does not set in wet conditions or under water. In embodiments, non-hydraulic cement sets as it dries and reacts with CO₂ in the air. In embodiments, non-hydraulic cement is resistant to degradation by chemicals after setting.

As used herein, the term “hydraulic cement” is used in accordance with its plain ordinary meaning and refers to cement that sets in wet conditions due to a chemical reaction between the dry ingredients and water. In embodiments, the chemical reaction results in mineral hydrates that are either completely or nearly insoluble in water. In embodiments, hydraulic cement also refers to Portland Cement.

As used herein, the term “mixing” is used in accordance with its plain ordinary meaning and refers to any form of mixing and may include milling or grinding of substances in solid form.

As used herein, the term “mortar” is used in accordance with its plain ordinary meaning and refers to a material composed of binder(s).

As used herein, the term “negative carbon dioxide-emitting concrete-replacement material” refers to a material that has a net positive CO₂ absorption as opposed to having a lower carbon footprint. In embodiments, the present application contemplates a material that produces carbon credits. In embodiments, the concrete-replacement material absorbs more carbon dioxide than is emitted.

As used herein, the term “seawater” is used in accordance with its plain ordinary meaning and refers to water from the sea or ocean. In embodiments, seawater includes various salts, dissolved inorganic (e.g., minerals) and organic compounds, and other particulates.

As used herein, the term “silane” is used in accordance with its plain ordinary meaning. In embodiments, silane is used as a coupling reagent between two dissimilar materials, which creates critical surface tension.

As used herein, the term “slag” is used in accordance with its plain ordinary meaning and means any type of slag, and may be used interchangeably with “ground-granulated blast-furnace slag.” Ground-granulated blast-furnace slag (“GGBFS”) refers to a composition obtained by quenching molten iron slag (a by-product of iron and steel-making) from a blast furnace in water or steam, to produce a glassy, granular product that is then dried and ground into a fine powder. In embodiments, slag includes any by-product following the separation (e.g., via smelting) of a metal from its raw ore that has cementitious components and/or characteristics. In embodiments, slag includes, but is not limited to, arc furnace slag, foundry furnace slag, induction furnace slag, and the like. In general, furnace slag is a non-metallic by-product comprising silicates, calcium-alumina-silicates. Slag may include slag from any metal, for example and without limitation steel, iron, copper, nickel, lead, aluminum, and zinc. Without being bound to any one theory, the slags contemplated herein relate to the use as a binder, which provides hydraulicity. The hydraulicity in turn may modulate the compression strength of the material. As contemplated herein, the use of ground-granulated blast-furnace slag reduces iron waste disposal in landfills. In some embodiments, the slag satisfies the ASTM requirements.

As used herein, the term “slurry” is used in accordance with its plain ordinary meaning and refers to a mixture of denser solids suspended in liquid. In embodiments, “brine slurry” refers to desalinated water waste product.

As used herein, the term “structural component” refers to any vertical or horizontal load-bearing member of a structure which supports dead or live loads in addition to its own weight and includes, but is not limited to, a foundation, an exterior or interior load-bearing wall, a column, a column beam, a floor, and a roof structure.

As used herein, the term “mold” refers to any container or form used to give shape to the material. In embodiments, a mold includes a well.

### Pozzolans

Without being bound by theory, particle size of the pozzolan(s) may affect reactivity of the material. For example, smaller particle size may provide increased reactivity. The pozzolan(s) may be provided at any particle size. In embodiments, at least about 90% of the particles of the pozzolan(s) fit through a mesh size of about #120 to about #1200. In embodiments, at least about 90% of the particles of the pozzolan(s) fit through a mesh size of about #120 to about #1000. In embodiments, at least about 90% of the particles of the pozzolan(s) fit through a mesh size of about #120 to about #800. In embodiments, at least about 90% of the particles of the pozzolan(s) fit through a mesh size of about #120 to about #600. In embodiments, at least about 90% of the particles of the pozzolan(s) fit through a mesh size of about #120 to about #400. In embodiments, at least about 90% of the particles of the pozzolan(s) fit through a mesh size of about #120 to about #325. In embodiments, at least about 90% of the particles of the pozzolan(s) fit through a mesh size of about #200 to about #1200. In embodiments, at least about 90% of the particles of the pozzolan(s) fit through a mesh size of about #200 to about #1000. In embodiments, at least about 90% of the particles of the pozzolan(s) fit through a mesh size of about #200 to about #800. In embodiments, at least about 90% of the particles of the pozzolan(s) fit through a mesh size of about #200 to about #700. In embodiments, at least about 90% of the particles of the pozzolan(s) fit through a mesh size of about #200 to about #600. In embodiments, at least about 90% of the particles of the pozzolan(s) fit through a mesh size of about #200 to about #500. In embodiments, at least about 90% of the particles of the pozzolan(s) fit through a mesh size of about #200 to about #400. In embodiments, at least about 90% of the particles of the pozzolan(s) fit through a mesh size of about #200 to about #325. Mesh size can be any value or subrange within the recited ranges.

In embodiments, at least about 95% of the particles of the pozzolan(s) fit through a mesh size of about #120 to about #1200. In embodiments, at least about 96% of the particles of the pozzolan(s) fit through a mesh size of about #120 to about #1200. In embodiments, at least about 97% of the particles of the pozzolan(s) fit through a mesh size of about #120 to about #1200. In embodiments, at least about 98% of the particles of the pozzolan(s) fit through a mesh size of about #120 to about #1200. In embodiments, at least about 99% of the particles of the pozzolan(s) fit through a mesh size of about #120 to about #1200. In embodiments, at least about 98% of the particles of the pozzolan(s) fit through a mesh size of about #120 to about #1000. In embodiments, at least about 98% of the particles of the pozzolan(s) fit through a mesh size of about #120 to about #800. In embodiments, at least about 98% of the particles of the pozzolan(s) fit through a mesh size of about #120 to about #600. In embodiments, at least about 98% of the particles of the pozzolan(s) fit through a mesh size of about #120 to about #400. In embodiments, at least about 98% of the particles of the pozzolan(s) fit through a mesh size of about #120 to about #325. In embodiments, at least about 98% of the particles of the pozzolan(s) fit through a mesh size of about #200 to about #1200. In embodiments, at least about 98% of the particles of the pozzolan(s) fit through a mesh size of about #200 to about #1000. In embodiments, at least about 98% of the particles of the pozzolan(s) fit through a mesh size of about #200 to about #800. In embodiments, at least about 98% of the particles of the pozzolan(s) fit through a mesh size of about #200 to about #700. In embodiments, at least about 98% of the particles of the pozzolan(s) fit through a mesh size of about #200 to about #600. In embodiments, at least about 98% of the particles of the pozzolan(s) fit through a mesh size of about #200 to about #500. In embodiments, at least about 98% of the particles of the pozzolan(s) fit through a mesh size of about #200 to about #400. In embodiments, at least about 98% of the particles of the pozzolan(s) fit through a mesh size of about #200 to about #325. Mesh size can be any value or subrange within the recited ranges.

### Natural Pozzolans

A natural pozzolan is a raw pozzolan that is found in natural deposits. In embodiments, the natural pozzolan is not calcined. A material is referred to as “calcined” when it has been heated below the temperature of fusion to alter its composition or physical state.

Natural pozzolans have been used to replace cement clinker in the production of Portland Cement. Cement clinker is a solid material produced by sintering limestone and aluminosilicate material comprising four mineral phases: two calcium silicates, alite (Ca₃Si) and belite (Ca₂Si), tricalcium aluminate (Ca₃Al) and calcium aluminoferrite (Ca₄AlFe). The clinker is ground to a fine powder and used as the binder, where a small amount of gypsum must be added to avoid the flash setting of the tricalcium aluminate (Ca₃Al₂O₆), the most reactive mineral phase (exothermic hydration reaction) in Portland clinker.

In contrast, the reactive chemical composition of pozzolans and natural pozzolans may comprise, but not limited to, silica (SiO₂), alumina (Al₂O₃), and iron oxide (Fe₂O₃). Natural pozzolans encompass a broad range of materials that include, but are not limited to, volcanic rock (rhyolite, obsidian, pitchstone, pumice, basalt or trap, and andesite) volcanic ash, sedimentary clays and shales, diatomaceous earth, and olivine.

Despite the advantages and historical use of natural pozzolans in the production of Portland cement-based concrete as clinker alternatives, there are several obstacles or disadvantages: the use of pozzolans may reduce the early strength of concrete, making such cements unsuitable for precast applications and potentially increasing construction times. They also may increase water demand during concrete production and can lower resistance to carbonation, which raises the risk of corrosion to carbon (black) steel reinforcement. However, the materials and methods described herein provide improved alternatives.

In embodiments, the natural pozzolan used in a composition or method provided herein is selected from rhyolite, obsidian, pitchstone, pumice, basalt, andesite, volcanic ash, sedimentary clay, shale, wollastanite, opaline shale, diatomaceous earth, olivine, and combinations thereof. In embodiments, the natural pozzolan includes rhyolite. In embodiments, the natural pozzolan includes obsidian. In embodiments, the natural pozzolan includes pitchstone. In embodiments, the natural pozzolan includes pumice. In embodiments, the natural pozzolan includes basalt. In embodiments, the natural pozzolan includes andesite. In embodiments, the natural pozzolan includes volcanic ash. In embodiments, the natural pozzolan includes sedimentary clay. In embodiments, the natural pozzolan includes shale. In embodiments, the natural pozzolan includes wollastanite. In embodiments, the natural pozzolan includes diatomaceous earth. In embodiments, the natural pozzolan includes opaline shale. In embodiments, the natural pozzolan includes olivine.

In embodiments, the natural pozzolan used in a composition or method provided expressly excludes one or more of the natural pozzolans listed herein.

### Natural Pozzolans: Volcanic Rock

Rhyolite is a silica-rich volcanic rock, which has a fine-grain or glassy in texture. It is formed from magma rich in silica that is extruded from a volcanic vent to cool quickly on the surface rather than slowly in the subsurface. The mineral composition of rhyolite comprises quartz, sanidine, and plagioclase, with minor amounts of hornblende and biotite. Chemically, the composition of rhyolite generally comprises SiO₂ and an alkali metal oxide, such as K₂O and Na₂O.

Obsidian is also formed from extruded lava from a volcano that cools rapidly with minimal crystal growth (i.e., glassy or fine-grained.) Like rhyolite, obsidian is extremely rich in SiO₂ at about 70 wt. % or more and also includes MgO and Fe₂O₃. While obsidian is used for manufacturing, the uses are typically for cutting and piercing tools.

Pitchstone is a volcanic glass similar to obsidian, formed when extruded lava rapidly cools. Pitchstone has a similar chemical composition to both rhyolite and obsidian, with the amount of SiO₂ ranging in the amount from about 70 wt. % to 75 wt. %. Pitchstone comprises minerals as quartz, alkali feldspar, and plagioclase, and in smaller amounts pyroxene and hornblende.

Pumice is a porous volcanic rock created when super-heated, highly pressurized rock is violently ejected from a volcano. Pumice typically has a porosity of approximately 64%-85% by volume. The mineral composition of pumice includes feldspar, augite, hornblend, and zircon. Pumice mainly comprises SiO₂, Al₂O₃, and minor amounts of other oxides such as FeO, Fe₂O₃, Na₂O, and K₂O.

Basalt is a fine-grained, extrusive igneous rock formed from the rapid cooling of low-viscosity lava rich in magnesium and iron. While basalt has a relatively lower amount of SiO₂ compared to other common igneous rocks, basalt generally has a composition of 45-52 wt. % SiO₂, 2-5 wt. % total alkalis, 0.5-2.0 wt. % TiO₂, 5-14% wt. %, and 14 wt. % Al₂O₃. Basalt may include additional components, including (without limitation) calcium oxide and/or magnesium oxide.

Andesite is a fine-grained volcanic rock that forms as a result of the rapid cooling and solidification of lava due to the eruption of arc volcanoes or oozing fissures. Andesite contains sodium-rich plagioclase feldspar (Na,Ca)[(Si,Al)AlSi₂]O₈ and may contain (usually <20%) hornblende amphibole, biotite, pyroxene and quartz minerals. In addition, andesite compositions include 52-63% silicon dioxide as well as an alkali oxide content (e.g. Na₂O, K₂O) ranging from 0 to 7% w/w. Andesite compositions are referred to respectively as low-silica or high-silica andesites when they contain either 52-57% or 57-63% SiO₂.

Olivine is a magnesium iron silicate found abundantly in the earth's upper mantel as a dense aggregate. Olivine is chemically represented as (Mg,Fe)₂SiO₄. Generally, olivine is abundant in low-silica mafic and ultramafie igneous rocks

### Manmade Pozzolans

Other materials may have pozzolanic activity, including some man-made materials. In some embodiments, the compositions and methods described herein may utilize pozzolans, including non-natural (e.g., manmade) pozzolans. In embodiments, manmade pozzolans are calcined materials. A material is referred to as “calcined” when it has been heated below the temperature of fusion to alter its composition or physical state. In embodiments, manmade pozzolans are recycled materials from industry (e.g., GGBFS).

Non-limiting examples of manmade pozzolans include metakaolin, fly ash (e.g., Class C fly ash), silica fume, ground glass (e.g., ground waste glass), slag (e.g. ground-granulated blast-furnace slag, blast-furnace slag, steel-furnace slag, basic-oxygen-furnace slag, electric-arc-furnace slag, ladle slag, copper slag, steel slag, iron slag, lead slag, nickel slag, zinc slag, aluminum slag, slag from other metals), burned organic matter residues (e.g., rice husk ash or rice hull ash), expanded clay, expanded shale, and calcine clay, and combinations thereof.

In embodiments, the manmade pozzolan used in a composition or method provided includes metakaolin. In embodiments, the manmade pozzolan includes fly ash. In embodiments, the manmade pozzolan includes silica fume. In embodiments, the manmade pozzolan includes burned organic matter residue. In embodiments, the manmade pozzolan includes ground glass. In embodiments, the manmade pozzolan includes ground waste glass. In embodiments, the manmade pozzolan includes slag. In embodiments, the manmade pozzolan includes ground-granulated blast-furnace slag. In embodiments, the manmade pozzolan includes blast-furnace slag. In embodiments, the manmade pozzolan includes steel-furnace slag. In embodiments, the manmade pozzolan includes basic-oxygen-furnace slag. In embodiments, the manmade pozzolan includes electric-arc-furnace slag. In embodiments, the manmade pozzolan includes ladle slag. In embodiments, the manmade pozzolan includes copper slag. In embodiments, the manmade pozzolan includes steel slag. In embodiments, the manmade pozzolan includes iron slag. In embodiments, the manmade pozzolan includes lead slag. In embodiments, the manmade pozzolan includes nickel slag. In embodiments, the manmade pozzolan includes zinc slag. In embodiments, the manmade pozzolan includes aluminum slag. In embodiments, the manmade pozzolan includes slag from other metals. In embodiments, the manmade pozzolan includes burned organic matter residues. In embodiments, the manmade pozzolan includes rice husk ash (rice hull ash). In embodiments, the manmade pozzolan includes expanded clay. In embodiments, the manmade pozzolan includes expanded shale. In embodiments, the manmade pozzolan includes calcine clay.

In embodiments, the materials described herein may be chemically treated (e.g., with acid) prior to use. In embodiments, the materials described herein are not chemically treated prior to use.

In embodiments, the manmade pozzolan used in a composition or method provided expressly excludes one or more of the manmade pozzolans listed herein.

Where the term “pozzolan” is recited, it is to be understood that natural pozzolan, manmade pozzolan, or a mixture thereof is intended.

### High-Range Water Reducers

As contemplated herein, the use of alternative cements, such as natural pozzolans generally increases the water demand. The addition of high-range water reducers to a concrete mixture can separately or concurrently result in increased slump, lower water to cement (w/c) ratio, and/or a reduced cement content required to obtain a given slump, which increases the workability and strength of the concrete. These admixtures also improve bonding between concrete and steel, prevents cracking, segregation, honeycombing, and bleeding. Water reducing admixtures are also known as plasticizers and are classified into plasticizers, mid-range plasticizers and super plasticizers. Normal plasticizers reduce water demand up to 10%. Mid-range plasticizers reduce water demand up to 15%. Super plasticizers reduce water demand up to 30%. Common plasticizers include calcium, sodium and ammonium lignosulfonate. Super plasticizers include acrylic polymer based, poly(carboxylate), and poly(carboxylate ethers). In embodiments, the plasticizers include, but are not limited to, calcium, sodium and ammonium lignosulfonate, acrylic polymer based, poly(carboxylate), poly(carboxylate ethers). In embodiments, depending on the conditions, a plasticizer may be used based on the chloride content of the cementious mixture.

In embodiments, commercial proprietary admixtures of plasticizers include, but are not limited to, EUCON 1037, EUCON 37, EUCON 537, EUCON SP, EUCON SPJ, PLASTOL 341, PLASTOL 341S, PLASTOL 5000, PLASTOL 5000/5000SCC, PLASTOL 5700, PLASTOL 6400, PLASTOL 6200EXT, PLASTOL 3425, PLASTOL 3420, PLASTOL ULTRA 209, PLASTOL SPC from Euclid Chemical; SIKAR VISCOCRETE®-1000, SIKA® VISCOCRETE®-2100, SIKAR VISCOCRETE®-2110, SIKAR VISCOCRETE®-4100, SIKAR VISCOCRETE®-6100, SIKAMENT®-686, SIKAMENT® SPMN, and SIKAMENT®-475 from Sika Chemical.

High-range water reducers can result in water reduction levels of 12% to more than 30% compared to concrete mixtures made without the addition of high-range water reducers. In embodiments, the high-range water reducers can result in water reduction levels of up to 50%. In embodiments, the high-range water reducers can result in water reduction levels from more than 0% to 50%, from more than 0% to 45%, from more than 0% to 40%, from more than 0% to 35%, from more than 0% to 30%, from more than 0% to 25%, from more than 0% to 20%, from more than 0% to 15%, from more than 0% to 10%, or from more than 0% to 5%. In embodiments, the high-range water reducers can result in water reduction levels from 5% to 50%, from 10% to 50%, from 15% to 50%, from 20% to 50%, from 25% to 50%, from 30% to 50%, from 35% to 50%, from 40% to 50%, or from 45% to 50%. In embodiments, the high-range water reducers can result in water reduction levels of 5%, of 6%, of 7%, of 8%, of 9%, of 10%, of 11%, of 12%, of 13%, of 14%, of 15%, of 16%, of 17%, of 18%, of 19%, of 20%, of 21%, of 22%, of 23%, of 24%, of 25%, of 26%, of 27%, of 28%, of 29%, of 30%, of 31%, of 32%, of 33%, of 34%, of 35%, of 36%, of 37%, of 38%, of 39%, of 40%, of 41%, of 42%, of 43%, of 44%, of 45%, of 46%, of 47%, of 48%, of 49%, or of 50%. The percentage may be any value or subrange within the recited ranges, including endpoints.

The dosage rate of a high-range water reducer is based upon the cement material and composition as well as the chemical properties of the water reducer and can range from, but is not limited to, 1 to 32 fl oz per 100 lbs of cementitious materials or 65 to 2090 ml/100 kg. In embodiments, the dosage rate is dependent upon the working conditions, such as temperature, humidity of environment, and the use of brine (i.e., recycled seawater), which includes an amount of chloride.

### Accelerating Admixtures

Contemplated herein is the use of accelerating admixtures. Accelerating admixtures reduce the initial setting time of concrete and improve the strength of concrete by increasing the rate of hydration. These admixtures are used in situations that require early removal of formwork, emergency repairs, or construction in low temperature regions. Examples of accelerating admixtures include triethenolamine, calcium formate, silica fume, finely divided silica gel, and calcium chloride. In embodiments, the accelerating admixture includes, but is not limited to, triethenolamine, calcium formate, silica fume, finely divided silica gel, and calcium chloride. In embodiments, the accelerating admixture includes but is not limited to, triethenolamine, calcium formate, finely divided silica gel, and calcium chloride. In embodiments, the accelerating admixture does not include silica fume.

### Retarding Admixtures

Contemplated herein are the use of retardants. Retarding admixtures slow down the rate of hydration of cement in its initial stage and increase the initial setting time of concrete. These admixtures are used in high temperature zones where the concrete will set quickly, which can lead to discontinuities in structure and poor bond between surfaces. In embodiments, retardants include, but are not limited to, citric acid, tartaric acid, glucose, lactose, maltose, cellobiose, sucrose, raffinose, phophates, phosphonates, borates, lead oxide, zinc oxide, magnesium salts, fluorates, unrefined calcium, sodium, or ammonia. Some retardants can also act as water reducers and are defined by the ASTM as Type D admixtures (i.e, water reducing and retarding). Such mixtures include lignosulfonates, hydroxycarboxylic acids and salts of hydroxycarboxylic acids.

Set retardants can be applied at dosage rates of 2-10 oz per 100 lbs of cementitious material or 130-650 mL/100 kg cementitious material and are typically applied to the initial batch water for the concrete mixture. In embodiments, the retardants can be applied at dosage rates of 1-20 oz per 100 lbs of cementitious material. In embodiments, the retardants can be applied at dosage rates of 100-800 mL/100 kg of cementitious material.

In embodiments, the retardants can be applied at dosage rates of 1 oz per 100 lbs of cementitious material, 1 oz per 100 lbs of cementitious material, 2 oz per 100 lbs of cementitious material, 3 oz per 100 lbs of cementitious material, 4 oz per 100 lbs of cementitious material, 5 oz per 100 lbs of cementitious material, 6 oz per 100 lbs of cementitious material, 7 oz per 100 lbs of cementitious material, 8 oz per 100 lbs of cementitious material, 9 oz per 100 lbs of cementitious material, 10 oz per 100 lbs of cementitious material, 11 oz per 100 lbs of cementitious material, 12 oz per 100 lbs of cementitious material, 13 oz per 100 lbs of cementitious material, 14 oz per 100 lbs of cementitious material, 15 oz per 100 lbs of cementitious material, 16 oz per 100 lbs of cementitious material, 17 oz per 100 lbs of cementitious material, 18 oz per 100 lbs of cementitious material, 19 oz per 100 lbs of cementitious material, or 20 oz per 100 lbs of cementitious material. The dosage rate amount may be any value or subrange within the recited ranges, including endpoints.

In embodiments, the retardants can be applied at dosage rates of 100 mL/100 kg of cementitious material, 125 mL/100 kg of cementitious material, 150 mL/100 kg of cementitious material, 175 mL/100 kg of cementitious material, 200 mL/100 kg of cementitious material, 225 mL/100 kg of cementitious material, 250 mL/100 kg of cementitious material, 275 mL/100 kg of cementitious material, 300 mL/100 kg of cementitious material, 325 mL/100 kg of cementitious material, 350 mL/100 kg of cementitious material, 375 mL/100 kg of cementitious material, 400 mL/100 kg of cementitious material, 425 mL/100 kg of cementitious material, 450 mL/100 kg of cementitious material, 475 mL/100 kg of cementitious material, 500 mL/100 kg of cementitious material, 525 mL/100 kg of cementitious material, 550 mL/100 kg of cementitious material, 575 mL/100 kg of cementitious material, 600 mL/100 kg of cementitious material, 625 mL/100 kg of cementitious material, 650 mL/100 kg of cementitious material, 675 mL/100 kg of cementitious material, 700 mL/100 kg of cementitious material, 725 mL/100 kg of cementitious material, 750 mL/100 kg of cementitious material, 775 mL/100 kg of cementitious material, or 800 mL/100 kg of cementitious material. The dosage rate amount may be any value or subrange within the recited ranges, including endpoints.

Surface retardants can be used at coverage rates of 100-300 ft²/gal or 2.45 m²/L-7.36 m²/L and are typically applied by spraying one or more thin, uniform coats on the top surface of concrete. In embodiments, surface retardants may be used at coverage rates of 100 ft²/gal, 110 ft²/gal, 120 ft²/gal, 130 ft²/gal, 140 ft²/gal, 150 ft²/gal, 160 ft²/gal, 170 ft²/gal, 180 ft²/gal, 190 ft²/gal, 200 ft²/gal, 210 ft²/gal, 220 ft²/gal, 230 ft²/gal, 240 ft²/gal, 250 ft²/gal, 260 ft²/gal, 270 ft²/gal, 280 ft²/gal, 290 ft²/gal, or 300 ft²/gal. The coverage rate amount may be any value or subrange within the recited ranges, including endpoints.

### Reactants

As used herein, the term “reactant” refers to one or more components of the cementitious mixture that provide reactivity to the mixture. Reactants include, for example, magnesium oxide, magnesium hydroxide, calcium carbonate, calcium oxide, calcium hydroxide, aluminum oxide, and aluminum hydroxide. In embodiments, the reactant includes magnesium oxide. In embodiments, the reactant includes magnesium hydroxide. In embodiments, the reactant includes calcium carbonate. In embodiments, the reactant includes calcium oxide. In embodiments, the reactant includes calcium hydroxide. In embodiments, the reactant includes aluminum oxide. In embodiments, the reactant includes aluminum hydroxide.

The reactant may be derived from any source. For example, the source of Mg(OH)₂ may be brucite.

Without being bound by theory, particle size of the reactant (or source of the reactant) may affect reactivity of the material. For example, smaller particle size may provide increased reactivity. The reactant may be provided at any particle size. In embodiments, at least about 90% of the particles of the reactant (or source of the reactant) fit through a mesh size of about #120 to about #1200. In embodiments, at least about 90% of the particles of the reactant (or source of the reactant) fit through a mesh size of about #120 to about #1000. In embodiments, at least about 90% of the particles of the reactant (or source of the reactant) fit through a mesh size of about #120 to about #800. In embodiments, at least about 90% of the particles of the reactant (or source of the reactant) fit through a mesh size of about #120 to about #600. In embodiments, at least about 90% of the particles of the reactant (or source of the reactant) fit through a mesh size of about #120 to about #400. In embodiments, at least about 90% of the particles of the reactant (or source of the reactant) fit through a mesh size of about #120 to about #325. In embodiments, at least about 90% of the particles of the reactant (or source of the reactant) fit through a mesh size of about #200 to about #1200. In embodiments, at least about 90% of the particles of the reactant (or source of the reactant) fit through a mesh size of about #200 to about #1000. In embodiments, at least about 90% of the particles of the reactant (or source of the reactant) fit through a mesh size of about #200 to about #800. In embodiments, at least about 90% of the particles of the reactant (or source of the reactant) fit through a mesh size of about #200 to about #700. In embodiments, at least about 90% of the particles of the reactant (or source of the reactant) fit through a mesh size of about #200 to about #600. In embodiments, at least about 90% of the particles of the reactant (or source of the reactant) fit through a mesh size of about #200 to about #500. In embodiments, at least about 90% of the particles of the reactant (or source of the reactant) fit through a mesh size of about #200 to about #400. In embodiments, at least about 90% of the particles of the reactant (or source of the reactant) fit through a mesh size of about #200 to about #325. Mesh size can be any value or subrange within the recited ranges.

In embodiments, at least about 95% of the particles of the reactant (or source of the reactant) fit through a mesh size of about #120 to about #1200. In embodiments, at least about 96% of the particles of the reactant (or source of the reactant) fit through a mesh size of about #120 to about #1200. In embodiments, at least about 97% of the particles of the reactant (or source of the reactant) fit through a mesh size of about #120 to about #1200. In embodiments, at least about 98% of the particles of the reactant (or source of the reactant) fit through a mesh size of about #120 to about #1200. In embodiments, at least about 99% of the particles of the reactant (or source of the reactant) fit through a mesh size of about #120 to about #1200. In embodiments, at least about 98% of the particles of the reactant (or source of the reactant) fit through a mesh size of about #120 to about #1000. In embodiments, at least about 98% of the particles of the reactant (or source of the reactant) fit through a mesh size of about #120 to about #800. In embodiments, at least about 98% of the particles of the reactant (or source of the reactant) fit through a mesh size of about #120 to about #600. In embodiments, at least about 98% of the particles of the reactant (or source of the reactant) fit through a mesh size of about #120 to about #400. In embodiments, at least about 98% of the particles of the reactant (or source of the reactant) fit through a mesh size of about #120 to about #325. In embodiments, at least about 98% of the particles of the reactant (or source of the reactant) fit through a mesh size of about #200 to about #1200. In embodiments, at least about 98% of the particles of the reactant (or source of the reactant) fit through a mesh size of about #200 to about #1000. In embodiments, at least about 98% of the particles of the reactant (or source of the reactant) fit through a mesh size of about #200 to about #800. In embodiments, at least about 98% of the particles of the reactant (or source of the reactant) fit through a mesh size of about #200 to about #700. In embodiments, at least about 98% of the particles of the reactant (or source of the reactant) fit through a mesh size of about #200 to about #600. In embodiments, at least about 98% of the particles of the reactant (or source of the reactant) fit through a mesh size of about #200 to about #500. In embodiments, at least about 98% of the particles of the reactant (or source of the reactant) fit through a mesh size of about #200 to about #400. In embodiments, at least about 98% of the particles of the reactant (or source of the reactant) fit through a mesh size of about #200 to about #325. Mesh size can be any value or subrange within the recited ranges.

### II. Compositions

In an aspect, the present embodiments provide a material for use, for example, as a cement and/or concrete material, the material comprising one or more of: a pozzolan; a reactant, or one or more accelerant; and an aqueous solution. In embodiments, the present technology includes a combination of reactants (e.g., MgO, Mg(OH)₂, or other reactant) at approximately 1:1 ratio with one or more pozzolans. In embodiments, the material comprises one or more of a natural pozzolan; ground-granulated blast-furnace slag; a reactant; an aqueous solution; and one or more accelerant. In embodiments, the material comprises one or more of a natural pozzolan; ground-granulated blast-furnace slag; and an aqueous solution comprising one or more accelerant. In embodiments, the material comprises one or more of a pozzolan; MgO; an aqueous solution; and one or more accelerant. In embodiments, the material comprises one or more of a pozzolan; Mg(OH)₂; an aqueous solution; and one or more accelerant. In embodiments, the pozzolan is a natural pozzolan. In embodiments, the pozzolan is a manmade pozzolan. The material further can include, for example, at least one filler. The material can include at least one aggregate, such as, for example, sand, gravel, crushed stone, and combinations thereof. The accelerant can include one or more nitrate, sulfate, sodium, chloride, and potassium. The material can be set upon mixing of the components. The setting can be done by mixing and then pouring the mixture.

The material described herein can be used in any suitable and desired way, including any as described herein. For example, the material can be used or formed into building materials (including as described herein), such as structural foundations and slabs (e.g., by pouring into forms with our without reinforcing material or supports such as for example, rebar, etc.), porches, tiles (e.g., roofing, flooring, wall, etc.), driveways, and sidewalks, blocks, preformed walls or components of walls, rooms, etc., bricks, pavers, articles such as bases of lamps, furniture, frames, and so forth. In short, the materials can be utilized for any end use as described anywhere herein.

In embodiments, the components of the cementitious mixture may be derived from any source. Different sources may have different levels of purity. While sources having any purity level may be used, it is to be understood that the level of purity may impact strength and/or cure time of the product.

In an aspect, the present embodiments provide a material such as a cement and/or a concrete-replacement material set by pouring a cementitious mixture, the poured cementitious mixture comprising: (a) a natural pozzolan; (b) ground-granulated blast-furnace slag; and (c) an aqueous solution comprising one or more accelerant. In an aspect, the present embodiments provide a material such as a cement and/or a concrete-replacement material set by pouring a cementitious mixture, the poured cementitious mixture comprising: (a) a natural pozzolan; (b) a manmade pozzolan; (c) an aqueous solution; and (d) one or more accelerant. In an aspect, the present embodiments provide a material such as a cement and/or a concrete-replacement material set by pouring a cementitious mixture, the poured cementitious mixture comprising: (a) a pozzolan; (b) slag; (c) an aqueous solution; and (d) one or more accelerant. In an aspect, the present embodiments provide a material such as a cement and/or a concrete-replacement material set by pouring a cementitious mixture, the poured cementitious mixture comprising: (a) a pozzolan; (b) MgO; (c) an aqueous solution; and (d) one or more accelerant. In an aspect, the present embodiments provide a material such as a cement and/or a concrete-replacement material set by pouring a cementitious mixture, the poured cementitious mixture comprising: (a) a pozzolan; (b) Mg(OH)₂; (c) an aqueous solution; and (d) one or more accelerant.

In an aspect, the present embodiments provide an artificial, stonelike material set by pouring a cementitious mixture, the poured cementitious mixture comprising: (a) a natural pozzolan; (b) ground-granulated blast-furnace slag; and (c) an aqueous solution comprising one or more accelerant. In an aspect, the present embodiments provide an artificial, stonelike material set by pouring a cementitious mixture, the poured cementitious mixture comprising: (a) a natural pozzolan; (b) a manmade pozzolan; (c) an aqueous solution; and (d) one or more accelerant. In an aspect, the present embodiments provide an artificial, stonelike material set by pouring a cementitious mixture, the poured cementitious mixture comprising: (a) a pozzolan; (b) slag; (c) an aqueous solution; and (d) one or more accelerant. In an aspect, the present embodiments provide an artificial, stonelike material set by pouring a cementitious mixture, the poured cementitious mixture comprising: (a) a pozzolan; (b) MgO; (c) an aqueous solution; and (d) one or more accelerant. In an aspect, the present embodiments provide an artificial, stonelike material set by pouring a cementitious mixture, the poured cementitious mixture comprising: (a) a pozzolan; (b) Mg(OH)₂; (c) an aqueous solution; and (d) one or more accelerant. In an aspect, a curable mixture configured to set in the presence of water comprises a reactant, a primary natural pozzolan(s) or pozzolan(s), wherein a proportion by weight of the pozzolan(s) is 80% to 120% of a proportion of reactant(s) by weight of the mixture, and at least one accelerant, wherein the at least one accelerant comprises magnesium chloride in the form of MgCl₂·6H₂O or magnesium nitrate in the form of Mg(NO₃)₂·6H₂O.

In embodiments, the accelerant comprises one or more nitrate, sulfate, sodium, chloride, and phosphate. In embodiments, the accelerant includes nitrate. In embodiments, the accelerant includes sulfate. In embodiments, the accelerant includes sodium. In embodiments, the accelerant includes chloride. In embodiments, the accelerant includes phosphate. In embodiments, addition of an increased amount of sulfate mitigates heat production when preparing the mixture at large scale, without negatively affecting strength of the final material.

In embodiments, the accelerating admixture is selected from triethenolamine, calcium formate, silica fume, finely divided silica gel, and calcium chloride. In embodiments, the accelerating admixture includes triethenolamine. In embodiments, the accelerating admixture includes calcium formate. In embodiments, the accelerating admixture includes silica fume. In embodiments, the accelerating admixture includes finely divided silica gel. In embodiments, the accelerating admixture includes calcium chloride.

In embodiments, the accelerant is added to an aqueous solution prior to addition to the pozzolan, slag, MgO, and/or Mg(OH)₂. In embodiments, the accelerant is combined with one or more of the pozzolan, slag, MgO, and/or Mg(OH)₂ prior to addition of the aqueous solution.

In embodiments, the poured cementitious mixture further comprises at least one aggregate. In embodiments, the at least one aggregate is selected from sand, gravel, lightweight aggregate, crushed stone, and combinations thereof. In embodiments, the at least one aggregate includes sand. In embodiments, the at least one aggregate includes gravel. In embodiments, the at least one aggregate includes lightweight aggregate. In embodiments, the at least one aggregate includes crushed stone. In embodiments, the at least one aggregate includes unprocessed (e.g., unground) slag. In embodiments, the at least one aggregate includes unprocessed (e.g., unground) glass (e.g., waste glass). The aggregate may be any size.

In embodiments, the average particle size of the aggregate is about 0.01 mm to about 12 mm. In embodiments, the average particle size of the aggregate is about 0.01 mm to about 3 mm. In embodiments, the average particle size of the aggregate is about 3 mm to about 8 mm. In embodiments, the average particle size of the aggregate is about 8 mm to about 12 mm.

In embodiments, the natural pozzolan is selected from rhyolite, obsidian, pitchstone, pumice, basalt, andesite, volcanic ash, sedimentary clay, sedimentary shale, calcined clay, rice husk ash, diatomaceous earth, metakaolin, olivine, and combinations thereof. In embodiments, the natural pozzolan is basalt.

In an aspect, the present embodiments provide a concrete-replacement material set by pouring a cementitious mixture, the poured cementitious mixture comprising: (a) a natural pozzolan; (b) granulated ground blast furnace slag; and, (c) an aqueous solution comprising one or more accelerant. In an aspect, the present embodiments provide a concrete-replacement material set by pouring a cementitious mixture, the poured cementitious mixture comprising: (a) a natural pozzolan; (b) a manmade pozzolan; (c) an aqueous solution; and (d) one or more accelerant. In an aspect, the present embodiments provide a concrete-replacement material set by pouring a cementitious mixture, the poured cementitious mixture comprising: (a) a pozzolan; (b) slag; (c) an aqueous solution; and (d) one or more accelerant. In an aspect, the present embodiments provide a concrete-replacement material set by pouring a cementitious mixture, the poured cementitious mixture comprising: (a) a pozzolan; (b) MgO; (c) an aqueous solution; and (d) one or more accelerant. In an aspect, the present embodiments provide a concrete-replacement material set by pouring a cementitious mixture, the poured cementitious mixture comprising: (a) a pozzolan; (b) Mg(OH)₂; (c) an aqueous solution; and (d) one or more accelerant.

In an aspect, the present embodiments provide an artificial, stonelike material set by pouring a cementitious mixture, the poured cementitious mixture comprising: (a) a natural pozzolan; (b) granulated ground blast furnace slag; and, (c) an aqueous solution comprising one or more accelerant. In an aspect, the present embodiments provide an artificial, stonelike material set by pouring a cementitious mixture, the poured cementitious mixture comprising: (a) a natural pozzolan; (b) granulated ground blast furnace slag; (c) an aqueous solution; and (d) one or more accelerant. In an aspect, the present embodiments provide an artificial, stonelike material set by pouring a cementitious mixture, the poured cementitious mixture comprising: (a) a pozzolan; (b) slag; (c) an aqueous solution; and (d) one or more accelerant. In an aspect, the present embodiments provide an artificial, stonelike material set by pouring a cementitious mixture, the poured cementitious mixture comprising: (a) a pozzolan; (b) MgO; (c) an aqueous solution; and (d) one or more accelerant. In an aspect, the present embodiments provide an artificial, stonelike material set by pouring a cementitious mixture, the poured cementitious mixture comprising: (a) a pozzolan; (b) Mg(OH)₂; (c) an aqueous solution; and (d) one or more accelerant.

In embodiments, the cementitious mixture includes MgO and/or Mg(OH)₂. In embodiments, the cementitious mixture includes MgO. In embodiments, the cementitious mixture includes Mg(OH)₂. In embodiments, the cementitious mixture includes MgO and Mg(OH)₂. The ratio of MgO to Mg(OH)₂ in the cementitious mixture may be any ratio. In embodiments, the ratio of MgO to Mg(OH)₂ in the cementitious mixture is 4:1 to 1:4. Any ratio of MgO to Mg(OH)₂ within that range may be used, for example 4:1, 3:1, 2:1, 1:1, 1:2, 1:3, 1:4, or any value or subrange therebetween.

In embodiments, the slag included in a mix may be replaced (or supplemented) by one or more other pozzolans, such as, for example and without limitation, Class C fly ash and/or any other material that includes similar cementitious properties that is capable of being combined with a reactant, e.g., magnesium oxide. According to some embodiments, one component of the dry mixes disclosed herein includes a primary cementitious component. In some configurations, the primary cementitious component comprises a pozzolan. In other embodiments, the primary cementitious component comprises a pozzolan, and/or another cementitious component that is configured to be combined with the magnesium oxide of the mix such that the component forms binder on its own in the presence of water or another liquid. According to some embodiments, any primary cementitious component conforms to all or at least some of the requirements set forth in ASTM C618.

In embodiments, the concrete-replacement material is set by pouring the cementitious mixture and then applying a curing technique to the poured cementitious mixture.

In embodiments, the artificial, stonelike material is set by pouring the cementitious mixture and then applying a curing technique to the poured cementitious mixture.

In embodiments, the ratio of reactant (MgO and/or Mg(OH)₂) to pozzolan (natural pozzolan and/or man-made pozzolan) in the cementitious mixture is about 1:5 to about 5:1 by wt. %. Any ratio of reactant to pozzolan within that range may be used, for example 1:5, 1:4, 1:3, 1:2, 1:1, 2:1, 3:1, 4:1, 5:1, or any value or subrange therebetween. In embodiments, the ratio of reactant to pozzolan (natural pozzolan and/or man-made pozzolan) in the cementitious mixture is about 1:1.

In embodiments, the ratio of man-made pozzolan to natural pozzolan in the cementitious mixture is about 1:5 to about 5:1 by wt. %. Any ratio of man-made pozzolan to natural pozzolan within that range may be used, for example 1:5, 1:4, 1:3, 1:2, 1:1, 2:1, 3:1, 4:1, 5:1, or any value or subrange therebetween.

In embodiments, the combined amount of reactant and pozzolan in the dry cementitious mixture (prior to addition of aqueous solution) is about 10 to about 40 wt. %. In embodiments, the combined amount of reactant and pozzolan in the dry cementitious mixture (prior to addition of aqueous solution) is about 10 to about 30 wt. %. In embodiments, the combined amount of reactant and pozzolan in the dry cementitious mixture (prior to addition of aqueous solution) is about 10 to about 20 wt. %. In embodiments, the combined amount of reactant and pozzolan in the dry cementitious mixture (prior to addition of aqueous solution) is about 15 to about 30 wt. %. In embodiments, the combined amount of reactant and pozzolan in the dry cementitious mixture (prior to addition of aqueous solution) is about 15 to about 20 wt. %.

In some embodiments, the proportions of reactant and pozzolan in the formulation (e.g., the dry formulation before any water and/or other liquid is added) are relatively equal to one another. For example, the proportion of the pozzolan by percentage of weight in the dry mix or formulation is 80% to 120% (e.g., 80%-120%, 90%-110%, 95%-105%, 98%-102%, 80%-100%, 85%-100%, 90%-100%, 95%-100%, 80%-90%, 85%-95%, 100%-120%, 100%-115%, 100%-110%, 100%-105%, 105%-115%, 105%-120%, values between the foregoing ranges, etc.) of the proportion of reactant by percentage of weight in the dry mix or formulation. In other embodiments, the proportion of the pozzolan by percentage of weight in the dry mix or formulation is 70% to 130% (e.g., 70%-130%, 70%-120%, 80%-130%, 80%-120%, 90%-110%, 95%-105%, 98%-102%, 70%-100%, 80%-100%, 85%-100%, 90%-100%, 95%-100%, 80%-90%, 85%-95%, 100%-120%, 100%-115%, 100%-110%, 100%-105%, 105%-115%, 105%-120%, values between the foregoing ranges, etc.) of the proportion of reactant by percentage of weight in the dry mix or formulation.

According to some embodiments, a formulation or mix comprises a combined reactant and pozzolan content, as a percentage by weight of the dry formulation or mix, that is 40% to 80%, e.g. 40% to 70% (e.g., 40%-70%, 50%-60%, 40%-60%, 40%-50%, 40%-45%, 45%-50%, 45%-55%, 45%-60%, 45%-65%, 45%-70%, 50%-55%, 50%-65%, 50%-70%, 55%-60%, 55%-65%, 55%-70%, 60%-65%, 60%-70%, other percentages between the foregoing ranges, etc.). In certain configurations, the combined proportions of reactant and pozzolan in the dry mixture (e.g., before the mixture is combined with water and/or another liquid) is at least 40% (e.g., at least 40%, 45%, 50%, 55%, 60%, 65%, greater than 65%, etc.), as desired or required. In some embodiments, the combined proportions of reactant and pozzolan in the dry mixture (e.g., before the mixture is combined with water and/or another liquid) is at least 15% (e.g., at least 15%, 20%, 25%, 30%, 35%, 40%, 45%, 50%, 55%, 60%, 65%, greater than 65%, etc.), as desired or required.

According to some embodiments, a formulation or mix comprises a combined reactant and pozzolan content, as a percentage by weight of the dry formulation or mix, that is 15% to 50% (e.g., 15%-50%, 20%-40%, 25%-35%, 15%-20%, 15%-25%, 15%-30%, 15%-35%, 15%-40%, 15%-45%, 20%-25%, 20%-30%, 20%-35%, 20%-40%, 20%-45%, 20%-50%, 25%-30%, 25%-40%, 25%-50%, 30%-35%, 30%-40%, 30%-50%, other percentages between the foregoing ranges, etc.).

In some embodiments, a formulation or mix comprises a reactant content, as a percentage by weight of the dry formulation or mix, that is 20% to 50% (e.g., 20%-50%, 20%-45%, 20%-40%, 20%-25%, 20%-30%, 20%-35%, 25%-50%, 25%-45%, 25%-40%, 25%-30%, 25%-35%, 25%-40%, 30%-50%, 30%-45%, 30%-35%, 30%-40%, 22%-28%, 23%-27%, other percentages between the foregoing ranges, etc.). In certain configurations, the proportion of reactant in the dry mixture (e.g., before the mixture is combined with water and/or another liquid) is less than 40% (e.g., below 40%, 39%, 38%, 37%, 36%, 35%, 34%, 33%, 32%, 31%, 30%, 25% or below 20%, 25%-30%, 20%-25%, 10%-20%, 5%-10%, 5%-15%, specific percentages between the foregoing values, etc.). In some embodiments, the proportion of reactant in the dry mixture (e.g., before the mixture is combined with water and/or another liquid) is less than 10% (e.g., below 10%, 9%, 8%, 7%, 6%, 5%, 4%, 3%, 2%, 1%, specific percentages between the foregoing values, etc.).

According to some arrangements, the proportion of reactant in the dry mixture (e.g., before the mixture is combined with water and/or another liquid) is 20% to 35% (e.g., 20%-35%, 20%-30%, 20%-25%, 22%-28%, 25%-30%, 25%-35%, 30%-35%, values between the foregoing ranges, etc.) of the dry mixture by weight. Likewise, in some arrangements, the proportion of the pozzolan in the dry mixture (e.g., before the mixture is combined with water and/or another liquid) is 20% to 35% (e.g., 20%-35%, 20%-30%, 20%-25%, 22%-28%, 25%-30%, 25%-35%, 30%-35%, values between the foregoing ranges, etc.) of the dry mixture by weight.

According to some arrangements, the proportion of reactant in the dry mixture (e.g., before the mixture is combined with water and/or another liquid) is 5% to 20% (e.g., 5%-20%, 5%-15%, 5%-10%, 10%-20%, 10%-15%, values between the foregoing ranges, etc.) of the dry mixture by weight. Likewise, in some arrangements, the proportion of the pozzolan in the dry mixture (e.g., before the mixture is combined with water and/or another liquid) is 5% to 20% (e.g., 5%-20%, 5%-15%, 5%-10%, 10%-20%, 10%-15%, values between the foregoing ranges, etc.) of the dry mixture by weight.

In embodiments, the ratio of natural pozzolan to granulated ground blast furnace slag is from 75:25 by wt. % to 25:75 by wt. %. In embodiments, the ratio of natural pozzolan to granulated ground blast furnace slag is from 70:30 by wt. % to 30:70 by wt. %. In another embodiment, the ratio of natural pozzolan to granulated ground blast furnace slag is from 65:35 by wt. % to 35:65 by wt. %. In embodiments, the ratio of natural pozzolan to granulated ground blast furnace slag is from 60:40 by wt. % to 40:60 by wt. %. In embodiments, the ratio of natural pozzolan to granulated ground blast furnace slag is from 55:45 by wt. % to 45:55 by wt. %. In another embodiment, the ratio of natural pozzolan to granulated ground blast furnace slag is about 50:50 by wt. %. The ratio may be any subvalue or subrange there between, including endpoints, and including but not limited those specifically called out herein.

In embodiments, the ratio of pozzolan to slag is from 75:25 by wt. % to 25:75 by wt. %. In embodiments, the ratio of pozzolan to slag is from 70:30 by wt. % to 30:70 by wt. %. In another embodiment, the ratio of pozzolan to slag is from 65:35 by wt. % to 35:65 by wt. %. In embodiments, the ratio of pozzolan to slag is from 60:40 by wt. % to 40:60 by wt. %. In embodiments, the ratio of pozzolan to slag is from 55:45 by wt. % to 45:55 by wt. %. In another embodiment, the ratio of pozzolan to slag is about 50:50 by wt. %. The ratio may be any subvalue or subrange there between, including endpoints, and including but not limited those specifically called out herein.

In embodiments, the ratio of reactant to pozzolan is from 4:1 to 1:4 by wt. %. In embodiments, the ratio of reactant to pozzolan is from 3.5:1 to 1:3.5 by wt. %. In embodiments, the ratio of reactant to pozzolan is from 3:1 to 1:3 by wt. %. In embodiments, the ratio of reactant to pozzolan is from 2.5:1 to 1:2.5 by wt. %. In embodiments, the ratio of reactant to pozzolan is from 2:1 to 1:2 by wt. %. In embodiments, the ratio of reactant to pozzolan is from 1.1:1 to 1:1.1 by wt. %. The ratio may be any subvalue or subrange there between, including endpoints, and including but not limited those specifically called out herein.

In embodiments, the at least one aggregate is selected from sand, gravel, lightweight aggregate, crushed stone, and combinations thereof. In embodiments, the at least one aggregate is a non-reactive slag or crushed non-reactive slag.

In some embodiments the cementitious mixture does not include, and can specifically exclude, MgO obtained from a calcination reaction. In some embodiments the cementitious mixture includes MgO where less than 90%, 80%, 70%, 60%, 50%, 40%, 30%, 25%, 20%, 15%, 10%, or 5% of MgO obtained from a calcination reaction; or any sub value or subrange between 0% and 90%.

In embodiments, the amount of natural pozzolan relative to the amount of ground-granulated blast-furnace slag ranges from about 33 wt. % to about 300 wt. %. In some embodiments, the amount of natural pozzolan present relative to the amount of ground granulated blast-furnace slag ranges from about 50 wt. % to about 200 wt. %. In embodiments, the amount of natural pozzolan present relative the amount of ground granulated blast-furnace slag ranges from about 85 wt. % to about 115 wt. %. In some embodiments, the amount of natural pozzolan present relative to the amount of ground granulated blast-furnace slag ranges from about 90 wt. % to about 110 wt. %. In embodiments, the amount of natural pozzolan present relative to the amount of ground granulated blast-furnace slag is 33 wt. %, 34 wt. %, 35 wt. %, 40 wt. %, 45 wt. %, 50 wt. %, 55 wt. %, 60 wt. %, 65 wt. %, 70 wt. %, 75 wt. %, 80 wt. %, 85 wt. %, 90 wt. %, 95 wt. %, 100 wt. % 105 wt. %, 110 wt. %, 115 wt. %, 120 wt. %, 125 wt. %, 130 wt. %, 135 wt. %, 140 wt. %, 145 wt. %, 150 wt. %, 165 wt. %, 170 wt. %, 175 wt. %, 180 wt. %, 185, 190 wt. %, 195 wt. %, 200 wt. %, 205 wt. %, 210 wt. %, 215 wt. %, 220 wt. %, 230 wt. %, 235 wt. %, 240 wt. %, 245 wt. %, 250 wt. %, 265 wt. %, 270 wt. %, 275 wt. %, 280 wt. %, 285 wt. %, 290 wt. %, 295 wt. %, 300 wt. %; or any sub-value or subrange between 33% wt. % and 300 wt. %. The amount may be any subvalue or subrange there between, including endpoints, and including but not limited those specifically called out herein.

In embodiments, the amount of natural pozzolan relative to the amount of manmade pozzolan ranges can be included in the mixture at any ratio. In embodiments, the amount of natural pozzolan relative to the amount of manmade pozzolan ranges from about 33 wt. % to about 300 wt. %. In some embodiments, the amount of natural pozzolan present relative to the amount of manmade pozzolan ranges from about 50 wt. % to about 200 wt. %. In embodiments, the amount of natural pozzolan present relative the amount of manmade pozzolan ranges from about 85 wt. % to about 115 wt. %. In some embodiments, the amount of natural pozzolan present relative to the amount of manmade pozzolan ranges from about 90 wt. % to about 110 wt. %. In embodiments, the amount of natural pozzolan present relative to the amount of manmade pozzolan is 33 wt. %, 34 wt. %, 35 wt. %, 40 wt. %, 45 wt. %, 50 wt. %, 55 wt. %, 60 wt. %, 65 wt. %, 70 wt. %, 75 wt. %, 80 wt. %, 85 wt. %, 90 wt. %, 95 wt. %, 100 wt. % 105 wt. %, 110 wt. %, 115 wt. %, 120 wt. %, 125 wt. %, 130 wt. %, 135 wt. %, 140 wt. %, 145 wt. %, 150 wt. %, 165 wt. %, 170 wt. %, 175 wt. %, 180 wt. %, 185, 190 wt. %, 195 wt. %, 200 wt. %, 205 wt. %, 210 wt. %, 215 wt. %, 220 wt. %, 230 wt. %, 235 wt. %, 240 wt. %, 245 wt. %, 250 wt. %, 265 wt. %, 270 wt. %, 275 wt. %, 280 wt. %, 285 wt. %, 290 wt. %, 295 wt. %, 300 wt. %; or any sub-value or subrange between 33% wt. % and 300 wt. %. The amount may be any subvalue or subrange there between, including endpoints, and including but not limited those specifically called out herein.

In embodiments, the amount of nitrate present relative to the amount of pozzolan, e.g. ground-granulated blast furnace slag, ranges from about 2 wt. % to about 30 wt. %. In embodiments, the amount of nitrate present relative to the amount of pozzolan, e.g. ground-granulated blast furnace slag, ranges from about 2 wt. % to about 12 wt. %. In embodiments, the amount of nitrate present relative to the amount of pozzolan, e.g. ground-granulated blast furnace slag, ranges from about 15 wt. % to about 30 wt. %. In embodiments, the amount of nitrate present relative to the amount of pozzolan, e.g. ground-granulated blast furnace slag, is about 2 wt. %, 3 wt. %, 4 wt. %, 5 wt. %, 6 wt. %, 7 wt. %, 8 wt. %, 9 wt. %, 10 wt. %, 11 wt. %, 12 wt. %, 13 wt. %, 14 wt. %, 15 wt. %, 16 wt. %, 17 wt. %, 18 wt. %, 19 wt. %, 20 wt. %, 21 wt. %, 22 wt. %, 23 wt. %, 24 wt. %, 25 wt. %, 26 wt. %, 27 wt. %, 28 wt. %, 29 wt. %, or 30 wt. %. The amount may be any subvalue or subrange there between, including endpoints, and including but not limited those specifically called out herein.

In embodiments, the amount of nitrate present relative to the amount of reactant ranges from about 2 wt. % to about 30 wt. %. In embodiments, the amount of nitrate present relative to the amount of reactant ranges from about 2 wt. % to about 12 wt. %. In embodiments, the amount of nitrate present relative to the amount of reactant ranges from about 15 wt. % to about 30 wt. %. In embodiments, the amount of nitrate present relative to the amount of reactant is about 2 wt. %, 3 wt. %, 4 wt. %, 5 wt. %, 6 wt. %, 7 wt. %, 8 wt. %, 9 wt. %, 10 wt. %, 11 wt. %, 12 wt. %, 13 wt. %, 14 wt. %, 15 wt. %, 16 wt. %, 17 wt. %, 18 wt. %, 19 wt. %, 20 wt. %, 21 wt. %, 22 wt. %, 23 wt. %, 24 wt. %, 25 wt. %, 26 wt. %, 27 wt. %, 28 wt. %, 29 wt. %, or 30 wt. %. The amount may be any subvalue or subrange there between, including endpoints, and including but not limited those specifically called out herein.

In embodiments, the amount of sulfate present relative to the amount of pozzolan, e.g. ground-granulated blast-furnace slag, ranges from about 0.1 wt. % to about 90 wt. %. In embodiments, the amount of sulfate present relative to the amount of pozzolan, e.g. ground-granulated blast-furnace slag, ranges from about 20 wt. % to about 110 wt. %. In embodiments, the amount of sulfate present relative to the amount of pozzolan, e.g. ground-granulated blast-furnace slag, ranges from about 20 wt. % to about 50 wt. %. In embodiments, the amount of sulfate present relative to the amount of pozzolan, e.g. ground-granulated blast-furnace slag, ranges from about 80 wt. % to about 110 wt. %. In embodiments, the amount of sulfate present relative to the amount of pozzolan, e.g. ground-granulated blast-furnace slag, is about 0.1 wt. %, 0.2 wt. %, 0.3 wt. %, 0.4 wt. %, 0.5 wt. %, 0.6 wt. %, 0.7 wt. %, 0.8 wt. %, 0.9 wt. %, 1 wt %, 2 wt. %, 3 wt. %, 4 wt. %, 5 wt. %, 6 wt. %, 7 wt. %, 8 wt. %, 9 wt. %, 10 wt. %, 11 wt. %, 12 wt. %, 13 wt. %, 14 wt. %, 15 wt. %, 16 wt. %, 17 wt. %, 18 wt. %, 19 wt. %, 20 wt. %, 30 wt. %, 40 wt. %, 50 wt. %, 60 wt. %, 70 wt. %, 80 wt. %, 90 wt. %, 100 wt. %, 110 wt. %; or subintegers thereof, including ranges between endpoints. For example, in embodiments, the amount of sulfate present relative to the amount of pozzolan, e.g. ground-granulated blast-furnace slag is 31 wt. %. In other embodiments, the amount of sulfate present relative to the amount of pozzolan, e.g. ground-granulated blast-furnace slag is 90 wt. %. The amount may be any subvalue or subrange there between, including endpoints, and including but not limited those specifically called out herein.

In embodiments, the amount of sulfate present relative to the amount of reactant ranges from about 0.1 wt. % to about 90 wt. %. In embodiments, the amount of sulfate present relative to the amount of reactant ranges from about 20 wt. % to about 110 wt. %. In embodiments, the amount of sulfate present relative to the amount of reactant ranges from about 20 wt. % to about 50 wt. %. In embodiments, the amount of sulfate present relative to the amount of reactant ranges from about 80 wt. % to about 110 wt. %. In embodiments, the amount of sulfate present relative to the amount of reactant is about 0.1 wt. %, 0.2 wt. %, 0.3 wt. %, 0.4 wt. %, 0.5 wt. %, 0.6 wt. %, 0.7 wt. %, 0.8 wt. %, 0.9 wt. %, 1 wt %, 2 wt. %, 3 wt. %, 4 wt. %, 5 wt. %, 6 wt. %, 7 wt. %, 8 wt. %, 9 wt. %, 10 wt. %, 11 wt. %, 12 wt. %, 13 wt. %, 14 wt. %, 15 wt. %, 16 wt. %, 17 wt. %, 18 wt. %, 19 wt. %, 20 wt. %, 30 wt. %, 40 wt. %, 50 wt. %, 60 wt. %, 70 wt. %, 80 wt. %, 90 wt. %, 100 wt. %, 110 wt. %; or subintegers thereof, including ranges between endpoints. For example, in embodiments, the amount of sulfate present relative to the amount of reactant is 31 wt. %. In other embodiments, the amount of sulfate present relative to the amount of reactant is 90 wt. %. The amount may be any subvalue or subrange there between, including endpoints, and including but not limited those specifically called out herein.

In embodiments, the amount of chloride present relative to the amount of pozzolan, e.g. ground-granulated blast-furnace slag ranges from about 0.1 wt. % to about 12 wt. %. In embodiments, the amount of chloride is dependent on the end use and the size of the batch. Without being bound to any one theory, the use of chloride assists with the density of the batch. In embodiments, the amount of chloride present relative to the amount of pozzolan, e.g. ground-granulated blast-furnace slag is about 0.1 wt. %, 0.2 wt. %, 0.3 wt. %, 0.4 wt. %, 0.5 wt. %, 0.6 wt. %, 0.7 wt. %, 0.8 wt. %, 0.9 wt. %, 1.0 wt. %, 1.1 wt. %, 1.2 wt. %, 1.3 wt. %, 1.4 wt. %, 1.5 wt. %, 1.6 wt. %, 1.7 wt. %, 1.8 wt. %, 1.9 wt. %, 2 wt. %, 3 wt. %, 4 wt. %, 5 wt. %, 6 wt. %, 7 wt. %, 8 wt. %, 9 wt. %, 10 wt. %, 11 wt. %, 12 wt %; or subintegers thereof. For example, in embodiments, the amount of chloride present relative to the amount of pozzolan, e.g. ground-granulated blast-furnace slag is 1.8 wt. %. The amount may be any subvalue or subrange there between, including endpoints, and including but not limited those specifically called out herein.

In embodiments, the amount of chloride present relative to the amount of reactant ranges from about 0.1 wt. % to about 12 wt. %. In embodiments, the amount of chloride is dependent on the end use and the size of the batch. In embodiments, the amount of chloride present relative to the amount of reactant is about 0.1 wt. %, 0.2 wt. %, 0.3 wt. %, 0.4 wt. %, 0.5 wt. %, 0.6 wt. %, 0.7 wt. %, 0.8 wt. %, 0.9 wt. %, 1.0 wt. %, 1.1 wt. %, 1.2 wt. %, 1.3 wt. %, 1.4 wt. %, 1.5 wt. %, 1.6 wt. %, 1.7 wt. %, 1.8 wt. %, 1.9 wt. %, 2 wt. %, 3 wt. %, 4 wt. %, 5 wt. %, 6 wt. %, 7 wt. %, 8 wt. %, 9 wt. %, 10 wt. %, 11 wt. %, 12 wt %; or subintegers thereof. For example, in embodiments, the amount of chloride present relative to the amount of reactant is 1.8 wt. %. The amount may be any subvalue or subrange there between, including endpoints, and including but not limited those specifically called out herein.

In embodiments, the amount of phosphate present relative to the amount of pozzolan, e.g. ground-granulated blast-furnace slag ranges from about 0.1 wt. % to about 20 wt. %. In embodiments, the amount of phosphate present relative to the amount of pozzolan, e.g. ground-granulated blast-furnace slag is about 0.1 wt. %, 0.2 wt. %, 0.3 wt. %, 0.4 wt. %, 0.5 wt. %, 0.6 wt. %, 0.7 wt. %, 0.8 wt. %, 0.9 wt. %, 1.0 wt. %, 1.1 wt. %, 1.2 wt. %, 1.3 wt. %, 1.4 wt. %, 1.5 wt. %, 1.6 wt. %, 1.7 wt. %, 1.8 wt. %, 1.9 wt. %, 2 wt. %, 3 wt. %, 4 wt. %, 5 wt. %, 6 wt. %, 7 wt. %, 8 wt. %, 9 wt. %, 10 wt. %, 11 wt. %, 12 wt. %, 13 wt. %, 14 wt. %, 15 wt. %, 16 wt. %, 17 wt. %, 18 wt. %, 19 wt. %, 20 wt. %; or subintegers thereof. The amount may be any subvalue or subrange there between, including endpoints, and including but not limited those specifically called out herein.

In embodiments, the amount of phosphate present relative to the amount of reactant ranges from about 0.1 wt. % to about 20 wt. %. In embodiments, the amount of phosphate present relative to the amount of reactant is about 0.1 wt. %, 0.2 wt. %, 0.3 wt. %, 0.4 wt. %, 0.5 wt. %, 0.6 wt. %, 0.7 wt. %, 0.8 wt. %, 0.9 wt. %, 1.0 wt. %, 1.1 wt. %, 1.2 wt. %, 1.3 wt. %, 1.4 wt. %, 1.5 wt. %, 1.6 wt. %, 1.7 wt. %, 1.8 wt. %, 1.9 wt. %, 2 wt. %, 3 wt. %, 4 wt. %, 5 wt. %, 6 wt. %, 7 wt. %, 8 wt. %, 9 wt. %, 10 wt. %, 11 wt. %, 12 wt. %, 13 wt. %, 14 wt. %, 15 wt. %, 16 wt. %, 17 wt. %, 18 wt. %, 19 wt. %, 20 wt. %; or subintegers thereof. The amount may be any subvalue or subrange there between, including endpoints, and including but not limited those specifically called out herein.

Other “low-carbon” concretes inject CO₂ gas into their mixture prior to curing to trap CO₂. However, this does not result in significant carbon capture from the atmosphere, and CO₂ must be captured from an industrial process, which may not be feasible. In contrast, the concrete replacement material described herein removes CO₂ from the air via a chemical reaction that takes place at room temperature. This reaction permanently mineralizes CO₂ in the concrete replacement material.

In embodiments, CO₂ is captured in the concrete replacement material or artificial, stonelike material. In embodiments, the CO₂ crystalizes in the concrete replacement material or artificial, stonelike material. In embodiments, retention of the CO₂ in the material results in increased strength of the material. In embodiments, the concrete-replacement material absorbs and retains at least 0.04 kg CO₂ per kg of concrete-replacement material. In embodiments, the concrete-replacement material absorbs and retains about 0.04 kg to about 1 kg CO₂ per kg of concrete-replacement material per year. In embodiments, the concrete-replacement material absorbs and retains about 0.04 kg to about 1 kg CO₂ per kg of concrete-replacement material per year. In embodiments, the concrete-replacement material absorbs and retains about 0.05 kg to about 1 kg CO₂ per kg of concrete-replacement material per year. In embodiments, the concrete-replacement material absorbs and retains about 0.07 kg to about 1 kg CO₂ per kg of concrete-replacement material per year. In embodiments, the concrete-replacement material absorbs and retains about 0.08 kg to about 1 kg CO₂ per kg of concrete-replacement material per year. In embodiments, the concrete-replacement material absorbs and retains about 0.09 kg to about 1 kg CO₂ per kg of concrete-replacement material per year. In embodiments, the concrete-replacement material absorbs and retains about 0.04 kg to about 0.9 kg CO₂ per kg of concrete-replacement material per year. In embodiments, the concrete-replacement material absorbs and retains about 0.04 kg to about 0.8 kg CO₂ per kg of concrete-replacement material per year. In embodiments, the concrete-replacement material absorbs and retains about 0.04 kg to about 0.7 kg CO₂ per kg of concrete-replacement material per year. In embodiments, the concrete-replacement material absorbs and retains about 0.09 kg to about 0.7 kg CO₂ per kg of concrete-replacement material per year.

In embodiments, the artificial, stonelike material absorbs and retains at least 0.04 kg CO₂ per kg of artificial, stonelike material. In embodiments, the artificial, stonelike material absorbs and retains about 0.04 kg to about 1 kg CO₂ per kg of artificial, stonelike material per year. In embodiments, the artificial, stonelike material absorbs and retains about 0.04 kg to about 1 kg CO₂ per kg of artificial, stonelike material per year. In embodiments, the artificial, stonelike material absorbs and retains about 0.05 kg to about 1 kg CO₂ per kg of artificial, stonelike material per year. In embodiments, the artificial, stonelike material absorbs and retains about 0.07 kg to about 1 kg CO₂ per kg of artificial, stonelike material per year. In embodiments, the artificial, stonelike material absorbs and retains about 0.08 kg to about 1 kg CO₂ per kg of artificial, stonelike material per year. In embodiments, the artificial, stonelike material absorbs and retains about 0.09 kg to about 1 kg CO₂ per kg of artificial, stonelike material per year. In embodiments, the artificial, stonelike material absorbs and retains about 0.04 kg to about 0.9 kg CO₂ per kg of artificial, stonelike material per year. In embodiments, the artificial, stonelike material absorbs and retains about 0.04 kg to about 0.8 kg CO₂ per kg of artificial, stonelike material per year. In embodiments, the artificial, stonelike material absorbs and retains about 0.04 kg to about 0.7 kg CO₂ per kg of artificial, stonelike material per year. In embodiments, the artificial, stonelike material absorbs and retains about 0.09 kg to about 0.7 kg CO₂ per kg of artificial, stonelike material per year.

In embodiments, the concrete-replacement material absorbs CO₂ and retains at least 5-52 weight % of the concrete-replacement material over a 15-year period.

In embodiments, the artificial, stonelike material absorbs CO₂ and retains at least 5-52 weight % of the artificial, stonelike material over a 15-year period.

In another aspect, the present embodiments provide a concrete-replacement material formed from a poured cementitious mixture and configured to absorb and retain carbon dioxide, the poured cementitious mixture comprising (a) a natural pozzolan; (b) granulated ground blast furnace slag; and, (c) optionally at least one aggregate. In another aspect, the present embodiments provide a concrete-replacement material formed from a poured cementitious mixture and configured to absorb and retain carbon dioxide, the poured cementitious mixture comprising (a) a pozzolan; (b) slag; and, (c) optionally at least one aggregate. In another aspect, the present embodiments provide a concrete-replacement material formed from a poured cementitious mixture and configured to absorb and retain carbon dioxide, the poured cementitious mixture comprising (a) a pozzolan; (b) MgO; and, (c) optionally at least one aggregate. In another aspect, the present embodiments provide a concrete-replacement material formed from a poured cementitious mixture and configured to absorb and retain carbon dioxide, the poured cementitious mixture comprising (a) a pozzolan; (b) Mg(OH)₂; and, (c) optionally at least one aggregate.

In another aspect, the present embodiments provide an artificial, stonelike material formed from a poured cementitious mixture and configured to absorb and retain carbon dioxide, the poured cementitious mixture comprising (a) a natural pozzolan; (b) granulated ground blast furnace slag; (c) an aqueous solution comprising one or more accelerant; and, (d) optionally at least one aggregate. In another aspect, the present embodiments provide an artificial, stonelike material formed from a poured cementitious mixture and configured to absorb and retain carbon dioxide, the poured cementitious mixture comprising (a) a natural pozzolan; (b) granulated ground blast furnace slag; (c) an aqueous solution; (d) one or more accelerant; and, (e) optionally at least one aggregate. In another aspect, the present embodiments provide an artificial, stonelike material formed from a poured cementitious mixture and configured to absorb and retain carbon dioxide, the poured cementitious mixture comprising (a) a pozzolan; (b) slag; (c) an aqueous solution (d) one or more accelerant; and, (e) optionally at least one aggregate. In another aspect, the present embodiments provide an artificial, stonelike material formed from a poured cementitious mixture and configured to absorb and retain carbon dioxide, the poured cementitious mixture comprising (a) a pozzolan; (b) MgO; (c) an aqueous solution; (d) one or more accelerant; and, (e) optionally at least one aggregate. In another aspect, the present embodiments provide an artificial, stonelike material formed from a poured cementitious mixture and configured to absorb and retain carbon dioxide, the poured cementitious mixture comprising (a) a pozzolan; (b) Mg(OH)₂; (c) an aqueous solution; (d) one or more accelerant; and, (e) optionally at least one aggregate.

In embodiments, the poured cementitious mixture absorbs and retains carbon dioxide over a period of time as it is cured and hardened.

In embodiments, the poured cementitious mixture absorbs CO₂ and retains at least 5-52 weight % of the material over a 15-year period.

In embodiments, the at least one aggregate is selected from sand, gravel, lightweight aggregate, crushed stone, and combinations thereof.

In embodiments, a proportion by weight of pozzolan (e.g., natural pozzolan, manmade pozzolan, or both) is 80% to 120% of a proportion of reactants by weight of the mixture. In embodiments, a proportion by weight of pozzolan (e.g., natural pozzolan, manmade pozzolan, or both) is 5:1 to 1:5 of a proportion of reactants by weight of the mixture. In embodiments, a sum of the proportions of reactants and the pozzolan(s) comprises at least 12% by weight of the mixture. In embodiments, the mixture does not include clinkers or Portland cement or gypsum. In some embodiments, the mixture does not comprise gypsum as an initial mixture ingredient. For example, in some embodiments, although the dry mixture does not include gypsum, gypsum in some final or intermediate form may be created after the dry mixture is combined with water (e.g., during after curing).

In embodiments, the mixes or formulations disclosed herein are configured to produce a final cured product that, once combined with water and/or one or more other liquids and provided with sufficient time to set, is suitable for long-term contact with reinforcing bar (rebar), mesh, other types of steel (beams, channels, rods, fasteners, etc.) and/or any other metal or material susceptible to corrosion. Accordingly, such formulations can be ubiquitously used in the construction industry where steel or other metallic reinforcement and/or contact is desired or required. However, in other embodiments, as discussed further herein, the formulations can be used in structural or non-structural applications irrespective of whether rebar or other metal contacts the final cured product resulting from such formulations.

In embodiments, the 28-day strength of the mixture once combined with water and permitted to cure is at least 2000 psi (e.g., at least 2000, 2100, 2200, 2300, 2400, 2500, 3000-3500, 3500-4000 psi, greater than 4000 psi, etc.). In embodiments, the 1-day strength of the mixture once combined with water and permitted to cure is at least 400 psi (e.g., 400, 500, 600, 700, 800, 900, 1000, 1100, 1200, 1300, 1400, 1500, 1600, 1700, 1800, 1900, 2000, 2000-2500, 2500-3000, greater than 3000 psi, etc.). In an aspect, the 1-day strength of the mixture once combined with water and permitted to cure is at least 600 psi. In some aspects, the 1-day strength of the mixture once combined with water and permitted to cure is at least 1000 psi. In some arrangements, the 1-day strength of the mixture once combined with water and permitted to cure is at least 1000 psi (e.g., 1000, 1100, 1200, 1300, 1400, 1500, 1600, 1700, 1800, 1900, 2000, 2500, 3000, 3500, 4000, 4500, psi, greater than 4500 psi, etc.). In some aspects, the 7-day strength of the mixture once combined with water and permitted to cure is at least 3000 psi. In some aspects, the 7-day strength of the mixture once combined with water and permitted to cure is at least 2000 psi (e.g., 2000, 2100, 2200, 2300, 2400, 2500, 2600, 2700, 2800, 2900, 3000, 3100, 3200, 3300, 3400, 3500, 3600, 3700, 3800, 3900, 4000, 4500, 5000, 5500 psi, greater than 5500 psi, etc.).

In an aspect, the cementitious mixture comprises a reactant comprising one or both of magnesium oxide and/or magnesium hydroxide. In an aspect, the cementitious mixture includes a reactant comprising one or more of magnesium oxide and/or magnesium hydroxide and/or calcium carbonate and/or calcium oxide and/or calcium hydroxide and/or aluminum oxide and/or aluminum hydroxide. In embodiments, the reactant includes magnesium oxide. In embodiments, the reactant includes magnesium hydroxide. In embodiments, the reactant includes calcium carbonate. In embodiments, the reactant includes calcium oxide. In embodiments, the reactant includes calcium hydroxide. In embodiments, the reactant includes aluminum oxide. In embodiments, the reactant includes aluminum hydroxide.

In an aspect, the cementitious mixture includes two or more reactants. In an aspect, the cementitious mixture includes three or more reactants. In embodiments, the reactant can be found in, but not limited to, natural pozzolan(s) and/or pozzolan such as basalt. In these instances, where reactants are found in and/or as a part of pozzolans, two pozzolans can be combined provided that the proportion of the reactants are within the proportions described herein. For example, slag and basalt (with sufficient reactant content) can be combined according to the proportions described herein. In an aspect, the sum of the proportions of the reactant(s) and the natural pozzolan(s) or pozzolan(s) is 15% to 50% (e.g., 15%-50%, 15%-45%, 15-40%, 15%-35%, 20%-50%, 20%-45%, 20%-40%, 20%-35%, 25%-50%, 25%-45%, 25%-40%, 25%-35%, 25%-30%, 30%-35%, values between the foregoing ranges, etc.) by weight of the mixture, and wherein the proportion by weight of the natural pozzolan(s) pozzolan(s) is 90% to 110% of the proportion of reactant(s) by weight of the mixture.

In some embodiments, the formulation or mix can comprise a combined reactant and natural pozzolan(s) and/or pozzolan(s) content, as a percentage by weight of the dry formulation or mix, that is 40% to 80% (e.g., 40%-80%, 40%-75%, 40%-70%, 40%-65%, 40%-60%, 40%-55%, 40%-50%, 40%-45%, 45%-80%, 45%-75%, 45%-70%, 45%-65%, 45%-60%, 45%-55%, 45%-50%, 50%-80%, 50%-75%, 50%-70%, 50%-65%, 50%-60%, 50%-55%, 55%-80%, 55%-75%, 55%-70%, 55%-65%, 55%-60%, 60%-80%, 60%-75%, 60%-70%, 60%-65%, 65%-80%, 65%-75%, 65%-70%, 70%-80%, 70%-75%, 75-80%, percentages between the foregoing ranges, etc.).

In some embodiments, the formulation or mix can comprise a combined reactant and natural pozzolan(s) and/or pozzolan(s), as a percentage by weight of the dry formulation or mix, that is 10% to 50% (e.g., 10%-50%, 10%-45%, 10%-40%, 10%-35%, 10%-30%, 10%-25%, 10%-20%, 10%-15%, 15%-50%, 15%-45%, 15%-40%, 15%-35%, 15%-30%, 15%-25%, 15%-20%, 20%-50%, 20%-45%, 20%-40%, 20%-35%, 20%-30%, 20%-25%, 25%-50%, 25%-45%, 25%-40%, 25%-35%, 25%-30%, 30%-50%, 30%-45%, 30%-40%, 30%-35%, 35%-50%, 35%-45%, 35%-40%, 40%-50%, 40%-45%, 45-50%, percentages between the foregoing ranges, etc.). According to some embodiments, the sum of the proportions of reactant and natural pozzolan(s) and/or pozzolan(s) is 40% to 70% (e.g., 40%-70%, 50%-60%, 40%-60%, 40%-50%, 40%-45%, 45%-50%, 45%-55%, 45%-60%, 45%-65%, 45%-70%, 50%-55%, 50%-65%, 50%-70%, 55%-60%, 55%-65%, 55%-70%, 60%-65%, 60%-70%, other percentages between the foregoing ranges, etc.) by weight of the mixture.

In some embodiments, the curable mix or formulation additionally comprises at least one accelerant. In some embodiments, the accelerant comprises at least one of the following: magnesium chloride, magnesium nitrate and magnesium sulfate. In some embodiments, a proportion by weight of the at least one accelerant is 15% to 50% (e.g., 15%-50%, 15%-45%, 15-40%, 15%-35%, 20%-50%, 20%-45%, 20%-40%, 20%-35%, 25%-50%, 25%-45%, 25%-40%, 25%-35%, 25%-30%, 30%-35%, values between the foregoing ranges, etc.) of the proportion of reactant(s) by weight of the mixture.

In embodiments, the ratio of natural pozzolan to granulated ground blast furnace slag is from 75:25 by wt. % to 25:75 by wt. %. In embodiments, the ratio of natural pozzolan to granulated ground blast furnace slag is from 70:30 by wt. % to 30:70 by wt. %. In another embodiment, the ratio of natural pozzolan to granulated ground blast furnace slag is from 65:35 by wt. % to 35:65 by wt. %. In embodiments, the ratio of natural pozzolan to granulated ground blast furnace slag is from 60:40 by wt. % to 40:60 by wt. %. In embodiments, the ratio of natural pozzolan to granulated ground blast furnace slag is from 55:45 by wt. % to 45:55 by wt. %. In another embodiment, the ratio of natural pozzolan to granulated ground blast furnace slag is about 50:50 by wt. %. The ratio may be any subvalue or subrange there between, including endpoints, and including but not limited those specifically called out herein.

In embodiments, the ratio of natural pozzolan to manmade pozzolan is from 75:25 by wt. % to 25:75 by wt. %. In embodiments, the ratio of natural pozzolan to manmade pozzolan is from 70:30 by wt. % to 30:70 by wt. %. In another embodiment, the ratio of natural pozzolan to manmade pozzolan is from 65:35 by wt. % to 35:65 by wt. %. In embodiments, the ratio of natural pozzolan to manmade pozzolan is from 60:40 by wt. % to 40:60 by wt. %. In embodiments, the ratio of natural pozzolan to manmade pozzolan is from 55:45 by wt. % to 45:55 by wt. %. In another embodiment, the ratio of natural pozzolan to manmade pozzolan is about 50:50 by wt. %. The ratio may be any subvalue or subrange there between, including endpoints, and including but not limited those specifically called out herein.

In embodiments, the at least one aggregate is selected from sand, gravel, lightweight aggregate, crushed stone, and combinations thereof.

In some embodiments the cementitious mixture does not include, and may specifically exclude, MgO obtained from a calcination reaction. In some embodiments the concrete mixture includes MgO where less than 90%, 80%, 70%, 60%, 50%, 40%, 30%, 25%, 20%, 15%, 10%, or 5% of MgO obtained from a calcination reaction; or any sub value or subrange between 0% and 90%.

In embodiments, the amount of natural pozzolan relative to the amount of ground-granulated blast-furnace slag ranges from about 33 wt. % to about 300 wt. %. In some embodiments, the amount of natural pozzolan present relative to the amount of ground granulated blast-furnace slag ranges from about 50 wt. % to about 200 wt. %. In embodiments, the amount of natural pozzolan present relative the amount of ground granulated blast-furnace slag ranges from about 85 wt. % to about 115 wt. %. In some embodiments, the amount of natural pozzolan present relative to the amount of ground granulated blast-furnace slag ranges from about 90 wt. % to about 110 wt. %. In embodiments, the amount of natural pozzolan present relative to the amount of ground granulated blast-furnace slag is 33 wt. %, 34 wt. %, 35 wt. %, 40 wt. %, 45 wt. %, 50 wt. %, 55 wt. %, 60 wt. %, 65 wt. %, 70 wt. %, 75 wt. %, 80 wt. %, 85 wt. %, 90 wt. %, 95 wt. %, 100 wt. % 105 wt. %, 110 wt. %, 115 wt. %, 120 wt. %, 125 wt. %, 130 wt. %, 135 wt. %, 140 wt. %, 145 wt. %, 150 wt. %, 165 wt. %, 170 wt. %, 175 wt. %, 180 wt. %, 185, 190 wt. %, 195 wt. %, 200 wt. %, 205 wt. %, 210 wt. %, 215 wt. %, 220 wt. %, 230 wt. %, 235 wt. %, 240 wt. %, 245 wt. %, 250 wt. %, 265 wt. %, 270 wt. %, 275 wt. %, 280 wt. %, 285 wt. %, 290 wt. %, 295 wt. %, 300 wt. %; or any sub-value or subrange between 33% wt. % and 300 wt. %. The amount may be any subvalue or subrange there between, including endpoints, and including but not limited those specifically called out herein.

In embodiments, the amount of nitrate present relative to the amount of slag, e.g. ground-granulated blast furnace slag ranges from about 2 wt. % to about 30 wt. %. In embodiments, the amount of nitrate present relative to the amount of slag, e.g. ground-granulated blast furnace slag ranges from about 2 wt. % to about 12 wt. %. In embodiments, the amount of nitrate present relative to the amount of slag, e.g. ground-granulated blast furnace slag ranges from about 15 wt. % to about 30 wt, %. In embodiments, the amount of nitrate present relative to the amount of slag, e.g. ground-granulated blast furnace slag is about 2 wt. %, 3 wt. %, 4 wt. %, 5 wt. %, 6 wt. %, 7 wt. %, 8 wt. %, 9 wt. %, 10 wt. %, 11 wt. %, 12 wt. %, 13 wt. %, 14 wt. %, 15 wt. %, 16 wt. %, 17 wt. %, 18 wt. %, 19 wt. %, 20 wt. %, 21 wt. %, 22 wt. %, 23 wt. %, 24 wt. %, 25 wt. %, 26 wt. %, 27 wt. %, 28 wt. %, 29 wt. %, or 30 wt. %. The amount may be any subvalue or subrange there between, including endpoints, and including but not limited those specifically called out herein.

In embodiments, the amount of sulfate present relative to the amount of slag, e.g. ground-granulated blast-furnace slag ranges from about 0.1 wt. % to about 90 wt. %. In embodiments, the amount of sulfate present relative to the amount of slag, e.g. ground-granulated blast-furnace slag ranges from about 20 wt. % to about 110 wt. %. In embodiments, the amount of sulfate present relative to the amount of slag, e.g. ground-granulated blast-furnace slag ranges from about 20 wt. % to about 50 wt. %. In embodiments, the amount of sulfate present relative to the amount of slag, e.g. ground-granulated blast-furnace slag ranges from about 80 wt. % to about 110 wt. %. In embodiments, the amount of sulfate present relative to the amount of slag, e.g. ground-granulated blast-furnace slag is about 0.1 wt. %, 0.2 wt. %, 0.3 wt. %, 0.4 wt. %, 0.5 wt. %, 0.6 wt. %, 0.7 wt. %, 0.8 wt. %, 0.9 wt. %, 1 wt %, 2 wt. %, 3 wt. %, 4 wt. %, 5 wt. %, 6 wt. %, 7 wt. %, 8 wt. %, 9 wt. %, 10 wt. %, 11 wt. %, 12 wt. %, 13 wt. %, 14 wt. %, 15 wt. %, 16 wt. %, 17 wt. %, 18 wt. %, 19 wt. %, 20 wt. %, 30 wt. %, 40 wt. %, 50 wt. %, 60 wt. %, 70 wt. %, 80 wt. %, 90 wt. %, 100 wt. %, 110 wt. %; or subintegers thereof, including ranges between endpoints. For example, in embodiments, the amount of sulfate present relative to the amount of slag, e.g. ground-granulated blast-furnace slag is 31 wt. %. In other embodiments, the amount of sulfate present relative to the amount of slag, e.g. ground-granulated blast-furnace slag is 90 wt. %. The amount may be any subvalue or subrange there between, including endpoints, and including but not limited those specifically called out herein.

In embodiments, the amount of sodium present relative to the amount of slag, e.g. ground-granulated blast-furnace slag ranges from about 0.1 wt. % to about 5 wt. %. In embodiments, the amount of chloride present relative to the amount of slag, e.g. ground-granulated blast-furnace slag is about 0.1 wt. %, 0.2 wt. %, 0.3 wt. %, 0.4 wt. %, 0.5 wt. %, 0.6 wt. %, 0.7 wt. %, 0.8 wt. %, 0.9 wt. %, 1.0 wt. %, 1.1 wt. %, 1.2 wt. %, 1.3 wt. %, 1.4 wt. %, 1.5 wt. %, 1.6 wt. %, 1.7 wt. %, 1.8 wt. %, 1.9 wt. %, 2 wt. %, 3 wt. %, 4 wt. %, 5 wt. %, 6 wt. %, 7 wt. %, 8 wt. %, 9 wt. %, 10 wt. %, 11 wt. %, 12 wt. %; or subintegers thereof. For example, in embodiments, the amount of sodium present relative to the amount of slag, e.g. ground-granulated blast-furnace slag is 4.5 wt. %. The amount may be any subvalue or subrange there between, including endpoints, and including but not limited those specifically called out herein.

In embodiments, the amount of chloride present relative to the amount of slag, e.g. ground-granulated blast-furnace slag ranges from about 0.1 wt. % to about 12 wt. %. In embodiments, the amount of chloride is dependent on the end use and the size of the batch. Without being bound to any one theory, the use of chloride assists with the density of the batch. In embodiments, the amount of chloride present relative to the amount of slag, e.g. ground-granulated blast-furnace slag is about 0.1 wt. %, 0.2 wt. %, 0.3 wt. %, 0.4 wt. %, 0.5 wt. %, 0.6 wt. %, 0.7 wt. %, 0.8 wt. %, 0.9 wt. %, 1.0 wt. %, 1.1 wt. %, 1.2 wt. %, 1.3 wt. %, 1.4 wt. %, 1.5 wt. %, 1.6 wt. %, 1.7 wt. %, 1.8 wt. %, 1.9 wt. %, 2 wt. %, 3 wt. %, 4 wt. %, 5 wt. %, 6 wt. %, 7 wt. %, 8 wt. %, 9 wt. %, 10 wt. %, 11 wt. %, 12 wt. %; or subintegers thereof. For example, in embodiments, the amount of chloride present relative to the amount of slag, e.g. ground-granulated blast-furnace slag is 1.8 wt. %. The amount may be any subvalue or subrange there between, including endpoints, and including but not limited those specifically called out herein.

In embodiments, the amount of phosphate present relative to the amount of slag, e.g. ground-granulated blast-furnace slag ranges from about 0.1 wt. % to about 20 wt. %. In embodiments, the amount of phosphate present relative to the amount of slag, e.g. ground-granulated blast-furnace slag is about 0.1 wt. %, 0.2 wt. %, 0.3 wt. %, 0.4 wt. %, 0.5 wt. %, 0.6 wt. %, 0.7 wt. %, 0.8 wt. %, 0.9 wt. %, 1.0 wt. %, 1.1 wt. %, 1.2 wt. %, 1.3 wt. %, 1.4 wt. %, 1.5 wt. %, 1.6 wt. %, 1.7 wt. %, 1.8 wt. %, 1.9 wt. %, 2 wt. %, 3 wt. %, 4 wt. %, 5 wt. %, 6 wt. %, 7 wt. %, 8 wt. %, 9 wt. %, 10 wt. %, 11 wt. %, 12 wt. %, 13 wt. %, 14 wt. %, 15 wt. %, 16 wt. %, 17 wt. %, 18 wt. %, 19 wt. %, 20 wt. %; or subintegers thereof. The amount may be any subvalue or subrange there between, including endpoints, and including but not limited those specifically called out herein.

In an aspect, the present embodiments provide a cementitious mixture comprising: (a) a aqueous solution comprising water and a natural pozzolan; and (b) granulated ground blast furnace slag; wherein the cementitious mixture has a pH of at least 8. In an aspect, the present embodiments provide a cementitious mixture comprising: (a) a aqueous solution comprising water; (b) a natural pozzolan; and (c) manmade pozzolan; wherein the cementitious mixture has a pH of at least 8. In an aspect, the present embodiments provide a cementitious mixture comprising: (a) a aqueous solution comprising water and a pozzolan; and (b) MgO; wherein the cementitious mixture has a pH of at least 8. In an aspect, the present embodiments provide a cementitious mixture comprising: (a) a aqueous solution comprising water and a pozzolan; and (b) Mg(OH)₂; wherein the cementitious mixture has a pH of at least 8.

In embodiments, the cementitious mixture has a pH of at least 8, at least 9, at least 10, at least 11, at least 12, or at least 13. In embodiments the cementitious mixture has a pH from 8 to 14, from 8 to 13, 8 to 12, 8 to 11, 8 to 10, or 8 to 9. In embodiments the cementitious mixture has a pH from 9 to 14, 9 to 13, 9 to 12, 9 to 11, or 9 to 10. In embodiments the cementitious mixture has a pH from 10 to 14, 10 to 13, 10 to 12, or 10 to 11. In embodiments the cementitious mixture has a pH from 11 to 14, 11 to 13, or 11 to 12. In embodiments the cementitious mixture has a pH from 12 to 14 or 12 to 13. In embodiments, the cementitious mixture has a pH from 13 to 14. The pH may be any subvalue or subrange there between, including endpoints, and including but not limited those specifically called out herein. In embodiments, the pH is the pH of sea water. In embodiments, the pH of sea water is about 8, e.g., about 8.1.

In embodiments, the ratio of natural pozzolan to granulated ground blast furnace slag is from 75:25 by wt. % to 25:75 by wt. %. In embodiments, the ratio of natural pozzolan to granulated ground blast furnace slag is from 70:30 by wt. % to 30:70 by wt. %. In another embodiment, the ratio of natural pozzolan to granulated ground blast furnace slag is from 65:35 by wt. % to 35:65 by wt. %. In embodiments, the ratio of natural pozzolan to granulated ground blast furnace slag is from 60:40 by wt. % to 40:60 by wt. %. In embodiments, the ratio of natural pozzolan to granulated ground blast furnace slag is from 55:45 by wt. % to 45:55 by wt. %. In another embodiment, the ratio of natural pozzolan to granulated ground blast furnace slag is about 50:50 by wt. %. The amount may be any subvalue or subrange there between, including endpoints, and including but not limited those specifically called out herein.

In embodiments, the ratio of natural pozzolan to manmade pozzolan is from 75:25 by wt. % to 25:75 by wt. %. In embodiments, the ratio of natural pozzolan to manmade pozzolan is from 70:30 by wt. % to 30:70 by wt. %. In another embodiment, the ratio of natural pozzolan to manmade pozzolan is from 65:35 by wt. % to 35:65 by wt. %. In embodiments, the ratio of natural pozzolan to manmade pozzolan is from 60:40 by wt. % to 40:60 by wt. %. In embodiments, the ratio of natural pozzolan to manmade pozzolan is from 55:45 by wt. % to 45:55 by wt. %. In another embodiment, the ratio of natural pozzolan to slag is about 50:50 by wt. %. The amount may be any subvalue or subrange there between, including endpoints, and including but not limited those specifically called out herein.

In embodiments, the at least one aggregate is selected from sand, gravel, lightweight aggregate, crushed stone, and combinations thereof.

In some embodiments the cementitious mixture does not include MgO, and may specifically exclude, obtained from a calcination reaction. In some embodiments the cementitious mixture includes MgO where less than 90%, 80%, 70%, 60%, 50%, 40%, 30%, 25%, 20%, 15%, 10%, or 5% of MgO obtained from a calcination reaction; or any sub value or subrange between 0% and 90%. The amount may be any subvalue or subrange there between, including endpoints, and including but not limited those specifically called out herein.

In embodiments, the amount of natural pozzolan relative to the amount of ground-granulated blast-furnace slag ranges from about 33 wt. % to about 300 wt. %. In some embodiments, the amount of natural pozzolan present relative to the amount of ground granulated blast-furnace slag ranges from about 50 wt. % to about 200 wt. %. In embodiments, the amount of natural pozzolan present relative the amount of ground granulated blast-furnace slag ranges from about 85 wt. % to about 115 wt. %. In some embodiments, the amount of natural pozzolan present relative to the amount of ground granulated blast-furnace slag ranges from about 90 wt. % to about 110 wt. %. In embodiments, the amount of natural pozzolan present relative to the amount of ground granulated blast-furnace slag is 33 wt. %, 34 wt. %, 35 wt. %, 40 wt. %, 45 wt. %, 50 wt. %, 55 wt. %, 60 wt. %, 65 wt. %, 70 wt. %, 75 wt. %, 80 wt. %, 85 wt. %, 90 wt. %, 95 wt. %, 100 wt. % 105 wt. %, 110 wt. %, 115 wt. %, 120 wt. %, 125 wt. %, 130 wt. %, 135 wt. %, 140 wt. %, 145 wt. %, 150 wt. %, 165 wt. %, 170 wt. %, 175 wt. %, 180 wt. %, 185, 190 wt. %, 195 wt. %, 200 wt. %, 205 wt. %, 210 wt. %, 215 wt. %, 220 wt. %, 230 wt. %, 235 wt. %, 240 wt. %, 245 wt. %, 250 wt. %, 265 wt. %, 270 wt. %, 275 wt. %, 280 wt. %, 285 wt. %, 290 wt. %, 295 wt. %, 300 wt. %; or any sub-value or subrange between 33% wt. % and 300 wt. %. The amount may be any subvalue or subrange there between, including endpoints, and including but not limited those specifically called out herein.

In embodiments, the amount of natural pozzolan relative to the amount of manmade pozzolan ranges from about 33 wt. % to about 300 wt. %. In some embodiments, the amount of natural pozzolan present relative to the amount of manmade pozzolan ranges from about 50 wt. % to about 200 wt. %. In embodiments, the amount of natural pozzolan present relative the amount of manmade pozzolan ranges from about 85 wt. % to about 115 wt. %. In some embodiments, the amount of natural pozzolan present relative to the amount of manmade pozzolan ranges from about 90 wt. % to about 110 wt. %. In embodiments, the amount of natural pozzolan present relative to the amount of manmade pozzolan is 33 wt. %, 34 wt. %, 35 wt. %, 40 wt. %, 45 wt. %, 50 wt. %, 55 wt. %, 60 wt. %, 65 wt. %, 70 wt. %, 75 wt. %, 80 wt. %, 85 wt. %, 90 wt. %, 95 wt. %, 100 wt. % 105 wt. %, 110 wt. %, 115 wt. %, 120 wt. %, 125 wt. %, 130 wt. %, 135 wt. %, 140 wt. %, 145 wt. %, 150 wt. %, 165 wt. %, 170 wt. %, 175 wt. %, 180 wt. %, 185, 190 wt. %, 195 wt. %, 200 wt. %, 205 wt. %, 210 wt. %, 215 wt. %, 220 wt. %, 230 wt. %, 235 wt. %, 240 wt. %, 245 wt. %, 250 wt. %, 265 wt. %, 270 wt. %, 275 wt. %, 280 wt. %, 285 wt. %, 290 wt. %, 295 wt. %, 300 wt. %; or any sub-value or subrange between 33% wt. % and 300 wt. %. The amount may be any subvalue or subrange there between, including endpoints, and including but not limited those specifically called out herein.

In embodiments, the amount of nitrate present relative to the amount of slag, e.g. ground-granulated blast furnace slag ranges from about 2 wt. % to about 30 wt. %. In embodiments, the amount of nitrate present relative to the amount of slag, e.g. ground-granulated blast furnace slag ranges from about 2 wt. % to about 12 wt. %. In embodiments, the amount of nitrate present relative to the amount of slag, e.g. ground-granulated blast furnace slag ranges from about 15 wt. % to about 30 wt. %. In embodiments, the amount of nitrate present relative to the amount of slag, e.g. ground-granulated blast furnace slag is about 2 wt. %, 3 wt. %, 4 wt. %, 5 wt. %, 6 wt. %, 7 wt. %, 8 wt. %, 9 wt. %, 10 wt. %, 11 wt. %, 12 wt. %, 13 wt. %, 14 wt. %, 15 wt. %, 16 wt. %, 17 wt. %, 18 wt. %, 19 wt. %, 20 wt. %, 21 wt. %, 22 wt. %, 23 wt. %, 24 wt. %, 25 wt. %, 26 wt. %, 27 wt. %, 28 wt. %, 29 wt. %, or 30 wt. %.

In embodiments, the amount of sulfate present relative to the amount of slag, e.g. ground-granulated blast-furnace slag ranges from about 0.1 wt. % to about 90 wt. %. In embodiments, the amount of sulfate present relative to the amount of slag, e.g. ground-granulated blast-furnace slag ranges from about 20 wt. % to about 110 wt. %. In embodiments, the amount of sulfate present relative to the amount of slag, e.g. ground-granulated blast-furnace slag ranges from about 20 wt. % to about 50 wt. %. In embodiments, the amount of sulfate present relative to the amount of slag, e.g. ground-granulated blast-furnace slag ranges from about 80 wt. % to about 110 wt. %. In embodiments, the amount of sulfate present relative to the amount of slag, e.g. ground-granulated blast-furnace slag is about 0.1 wt. %, 0.2 wt. %, 0.3 wt. %, 0.4 wt. %, 0.5 wt. %, 0.6 wt. %, 0.7 wt. %, 0.8 wt. %, 0.9 wt. %, 1 wt %, 2 wt. %, 3 wt. %, 4 wt. %, 5 wt. %, 6 wt. %, 7 wt. %, 8 wt. %, 9 wt. %, 10 wt. %, 11 wt. %, 12 wt. %, 13 wt. %, 14 wt. %, 15 wt. %, 16 wt. %, 17 wt. %, 18 wt. %, 19 wt. %, 20 wt. %, 30 wt. %, 40 wt. %, 50 wt. %, 60 wt. %, 70 wt. %, 80 wt. %, 90 wt. %, 100 wt. %, 110 wt. %; or subintegers thereof, including ranges between endpoints. For example, in embodiments, the amount of sulfate present relative to the amount of slag, e.g. ground-granulated blast-furnace slag is 31 wt. %. In other embodiments, the amount of sulfate present relative to the amount of slag, e.g. ground-granulated blast-furnace slag is 90 wt. %.

In embodiments, the amount of chloride present relative to the amount of slag, e.g. ground-granulated blast-furnace slag ranges from about 0.1 wt. % to about 12 wt. %. In embodiments, the amount of chloride is dependent on the end use and the size of the batch. Without being bound to any one theory, the use of chloride assists with the density of the batch. In embodiments, the amount of chloride present relative to the amount of slag, e.g. ground-granulated blast-furnace slag is about 0.1 wt. %, 0.2 wt. %, 0.3 wt. %, 0.4 wt. %, 0.5 wt. %, 0.6 wt. %, 0.7 wt. %, 0.8 wt. %, 0.9 wt. %, 1.0 wt. %, 1.1 wt. %, 1.2 wt. %, 1.3 wt. %, 1.4 wt. %, 1.5 wt. %, 1.6 wt. %, 1.7 wt. %, 1.8 wt. %, 1.9 wt. %, 2 wt. %, 3 wt. %, 4 wt. %, 5 wt. %, 6 wt. %, 7 wt. %, 8 wt. %, 9 wt. %, 10 wt. %, 11 wt. %, 12 wt. %; or subintegers thereof. For example, in embodiments, the amount of chloride present relative to the amount of slag, e.g. ground-granulated blast-furnace slag is 1.8 wt. %.

In embodiments, the process operates, effectively, at ambient pressure and/or gas temperatures. For example, in some embodiments, the curing step is performed at an ambient pressure. In some embodiments, the pressure is about 0.5 to about 10 atm, e.g., about 0.5, 0.6, 0.7, 0.8, 0.9, 1, 1.1, 1.2, 1.3, 1.4, 1.5, 1.6, 1.7, 1.8, 1.9, 2, 3, 4, 5, 6, 7, 8, 9 or 10 atm. In some embodiments, the pressure is applied beyond or after the curing step. In some embodiments, the temperature is about 15° C. to about to about 80° C., e.g., about 15° ° C., 20° C., 25° C., 30° C., 35° C., 40° ° C., 45° ° C., 50° C., 55° C., 60° C., 65° C., 70° C., 75° C. or 80° C. In some embodiments, the process includes a cooling step. In embodiments the cooling temperature is 30° C., 29° C., 28° C., 27° C., 26° C., 25, 24° C., 23° C., 22° C., 21° C., 20° C., 19° C., 18° C., 17° C., 16° C., 15° C., 14° C., 13° C., 12° C., 11° C., 10° C., 9° C., 8° C., 7° C., 6° C., 5° C., 4° C., 3° C., 2° C., 1° C., or 0° C.

In embodiments, the poured cementitious mixture comprises at least one accelerant, wherein the at least one accelerant comprises at least one of the following: magnesium chloride, magnesium nitrate, and magnesium sulfate. In some embodiments, the at least one accelerant comprises sodium hexametaphosphate ((NaPO₃)₆ or SHMP). In some embodiments, sodium hexametaphosphate is excluded. In some embodiments, when non-magnesium based accelerators (e.g., SHMP) are included in a mix, the content of such non-magnesium based accelerators is relatively small. For example, in some arrangements, the content of such non-magnesium based accelerators in the mix is less than 2% by weight of the entire dry mixture (e.g., 0%-2%, 0.1%-2%, 0%-1%, 0.1%-1%, 1%-2%, specific percentages between the foregoing ranges, etc.).

In embodiments, the at least one accelerant comprises magnesium chloride in the form of MgCl₂·6H₂O. In embodiments, the at least one accelerant comprises magnesium nitrate in the form of Mg(NO₃)₂·6H₂O. In an aspect, the at least one accelerant further comprises magnesium sulfate in the form of MgSO₄·7H₂O. In embodiments, the poured cementitious mixture comprises at least two accelerants. In embodiments, the poured cementitious mixture comprises two accelerants. In embodiments, the poured cementitious mixture comprises at least three accelerants. In embodiments, the poured cementitious mixture comprises three accelerants. In embodiments, the at least one accelerant is present in an amount of about 1 wt. % to about 5 wt. % In embodiments, the accelerant is present in an amount of about 1.0 wt. %, about 1.1 wt. %, about 1.2 wt. %, about 1.3 wt. %, about 1.4 wt. %, about 1.5 wt. %, about 1.6 wt. %, about 1.7 wt. %, about 1.8 wt. %, about 1.9 wt. %, about 2.0 wt. %, about 2.1 wt. %, about 2.2 wt. %, about 2.3 wt. %, about 2.4 wt. %, about 2.5 wt. %, about 2.6 wt. %, about 2.7 wt. %, about 2.8 wt. %, about 2.9 wt. %, about 3.0 wt. %, about 3.1 wt. %, about 3.2 wt. %, about 3.3 wt. %, about 3.4 wt. %, about 3.5 wt. %, about 3.6 wt. %, about 3.7 wt. %, about 3.8 wt. %, about 3.9 wt. %, about 4.0 wt. %, about 4.1 wt. %, about 4.2 wt. %, about 4.3 wt. %, about 4.4 wt. %, about 4.5 wt. %, about 4.6 wt. %, about 4.7 wt. %, about 4.8 wt. %, about 4.9 wt. %, or about 5.0 wt. %. In embodiments, the at least one accelerant is present in an amount of about 1 wt. %-5 wt. %, 1 wt. %-4.5 wt. %, 1 wt. %-4 wt. %, 1 wt. %-3.5 wt. %, 2 wt. %-5 wt. %, 2 wt. %-4.5 wt. %, 2 wt. %-4 wt. %, 2 wt. %-3.5 wt. %, 2.5 wt. %-5 wt. %, 2.5 wt. %-4.5 wt. %, 2.5 wt. %-4 wt. %, 2.5 wt. %-3.5 wt. %, 2.5 wt. %-3 wt. %, 3 wt. %-3.5 wt. %, or values between the foregoing ranges including endpoints.

In an aspect, the at least one accelerant comprises magnesium chloride in the form of MgCl₂·6H₂O or magnesium nitrate in the form of Mg(NO₃)₂·6H₂O, wherein a proportion by weight of MgCl₂·6H₂O or Mg(NO₃)₂·6H₂O is 0.25% to 30% (e.g., 0%, 0%-30%, 0%-25%, 0%-20%, 0%-15%, 0%-10%, 0%-5%, 1%-30%, 0.25%-25%, 0.25%-20%, 0.25%-15%, 0.25%-10%, 0.25%-5%, 2%-30%, 2%-25%, 2%-15%, 2%-12%, 2%-10%, 2%-8%, 2%-6%, 2%-5%, 2%-4%, 2%-3%, 3%-30%, 3%, 25%, 3%, 15%, 3%-12%, 3%-10%, 3%-8%, 3%-6%, 3%-5%, 3%-4%, 5%-30%, 5%-25%, 5%-20%, 5%-15%, 5%-12%, 5%-10%, 10%-30%, 10%-20%, 15%-25%, 15%-30%, values between the foregoing ranges, etc.) of the proportion of reactant(s) by weight of the mixture. In embodiments, a proportion by weight of MgCl₂·6H₂O or Mg(NO₃)₂·6H₂O is 80% to 120% (e.g., 80%-120%, 90%-110%, 95%-105%, 98%-102%, 80%-100%, 85%-100%, 90%-100%, 95%-100%, 80%-90%, 85%-95%, 100%-120%, 100%-115%, 100%-110%, 100%-105%, 105%-115%, 105%-120%, values between the foregoing ranges, etc.) of the proportion of reactant by weight of the mixture.

In an aspect, the at least one accelerant further comprises magnesium sulfate in the form of MgSO₄·7H₂O, wherein a proportion by weight of MgSO₄·7H₂O is 5% to 70% (e.g., 5%-70%, 5%-65%, 5%-60%, 5%-55%, 5%-50% 5%-45%, 15-40%, 15%-35%, 20%-50%, 20%-45%, 20%-40%, 20%-35%, 25%-50%, 25%-45%, 25%-40%, 25%-35%, 25%-30%, 30%-35%, values between the foregoing ranges, etc.) of the proportion of reactant(s) by weight of the mixture. In embodiments, a proportion by weight of MgSO₄·7H₂O is 90% to 140% (e.g., 90%-140%, 90%-130%, 90%-120%, 90%-110%, 95%-105%, 98%-102%, 80%-100%, 85%-100%, 90%-100%, 95%-100%, 80%-90%, 85%-95%, 100%-120%, 100%-115%, 100%-110%, 100%-105%, 105%-115%, 105%-120%, 105-130%, 105-140%, values between the foregoing ranges, etc.) of the proportion of reactant by weight of the mixture.

In an aspect, the curable mixture further comprises at least one accelerant, wherein the at least one accelerant comprises magnesium chloride in the form of MgCl₂·6H₂O or magnesium nitrate in the form of Mg(NO₃)₂·6H₂O. In an aspect, a proportion by weight of MgCl₂·6H₂O or Mg(NO₃)₂·6H₂O is 80% to 120% of the proportion of reactant(s) by weight of the mixture.

In an aspect, the curable mixture further comprises at least one accelerant, wherein the at least one accelerant comprises magnesium sulfate in the form of MgSO₄·7H₂O. In some embodiments, a proportion by weight of MgSO₄·7H₂O is 90% to 140% of the proportion of reactant(s) by weight of the mixture.

In an aspect, a proportion by weight of the at least one accelerant is 5% to 70% of the proportion of reactant(s) by weight of the mixture, determined by mass of mix. In an aspect, a proportion by weight of the at least one accelerant is 80% to 145% of the proportion of reactant(s) by weight of the mixture determined by mass of mix.

According to some embodiments, the at least one accelerant comprises MgCl₂·6H₂O or Mg(NO₃)₂·6H₂O, wherein a proportion by weight of MgCl₂·6H₂O or Mg(NO₃)₂·6H₂O is 0.1% to 30%, 1% to 30%, 2% to 30% (e.g., 2%-12%, 2%-10%, 2%-8%, 2%-6%, 2%-5%, 2%-4%, 2%-3%, 3%-12%, 3%-10%, 3%-8%, 3%-6%, 3%-5%, 3%-4%, 5%-12%, 5%-10%, 6%-10%, 6%-8%, values between the foregoing ranges, etc.) of the proportion of magnesium oxide by weight of the mixture, and the at least one accelerant further comprises magnesium sulfate in the form of MgSO₄·7H₂O, wherein a proportion by weight of MgSO₄·7H₂O is 15% to 50% (e.g., 15%-50%, 15%-45%, 15-40%, 15%-35%, 20%-50%, 20%-45%, 20%-40%, 20%-35%, 25%-50%, 25%-45%, 25%-40%, 25%-35%, 25%-30%, 30%-35%, values between the foregoing ranges, etc.) of the proportion of reactant by weight of the mixture.

In an aspect, at least one accelerant does not comprise phosphate or other phosphorous-based material. In some embodiments, at least one accelerant comprises a phosphate-based accelerant, wherein a proportion by weight of the phosphate-based accelerant is 0.1% to 5% of the proportion of reactant(s) by weight of the mixture. In some embodiments, the accelerant comprises a phosphate-based accelerant, wherein a proportion by weight of the phosphate-based accelerant is 0.1% to 5% (e.g., 0.1%-5%, 0.5%-5%, 1-5%, 1.5%-5%, 2%-5%, 2%-4.5%, 2%-4%, 2%-3.5%, 2.5%-5%, 2.5-4.5%, 2.5%-4%, 2.5%-3.5%, 2.5%-3%, 3%-3.5%, 3%-5%, 4%-5%, values between the foregoing ranges, etc.) of the proportion of reactant by weight of the mixture.

In an aspect, the at least one accelerant can be provided in a dry crystalline form, such as, for example, MgCl₂·6H₂O, Mg(NO₃)₂·6H₂O and/or MgSO₄·7H₂O. In other arrangements, however, the at least one accelerant can be provided in the mixes as part of a solution (e.g., in liquid form), as desired or required.

According to some embodiments, the mixture is configured to be combined with water to create a curable paste, wherein the amount of water used to create the curable paste is 25% to 125% by mass of the amount of reactant in the mixture. In some embodiments, the mass of water (and/or other liquid) added to the dry mix to form the curable product is 75% to 125% (e.g., 75-125, 80-120, 85-115, 90-110, 95-105, 75-100, 100-125%, percentages between the foregoing ranges, etc.) of the mass of MgO. In embodiments, the amount of water used to create the curable paste is 75% to 125% (e.g., 75%-125%, 75%-120%, 75%-115%, 75%-110%, 75%-105%, 75%-100%, 75%-95%, 75%-90%, 75%-85%, 75%-80%, 80%-125%, 80%-120%, 80%-115%, 80%-110%, 80%-105%, 80%-100%, 80%-95%, 80%-90%, 80%-85%, 85%-125%, 85%-120%, 85%-115%, 85%-110%, 85%-105%, 85%-100%, 85%-95%, 85%-90%, 90%-125%, 90%-120%, 90%-115%, 90%-110%, 90%-105%, 90%-100%, 90%-95%, 95%-125%, 95%-120%, 95%-115%, 95%-110%, 95%-105%, 95%-100%, 100%-125%, 100%-120%, 100%-115%, 100%-110%, 100%-105%, 105%-125%, 105%-120%, 105%-115%, 105%-110%, 110%-125%, 110%-120%, 110%-115%, 115%-125%, 115%-120%, 120%-125%, values between the foregoing ranges, etc.) by mass of the amount of MgO in the mixture.

In embodiments, a concrete-replacement material resulting from combining the mixture with water is suitable for long-term contact with reinforcing bar, mesh, steel and other materials susceptible to corrosion.

In embodiments, an artificial, stonelike material resulting from combining the mixture with water is suitable for long-term contact with reinforcing bar, mesh, steel and other materials susceptible to corrosion.

In embodiments, an artificial, stonelike material resulting from combining the mixture with water is suitable for long-term contact with reinforcing bar, mesh, steel and other materials susceptible to corrosion.

In embodiments, the mixture further comprises at least one filler material or other additive, the at least one filler or other additive is selected from the following: pumice or other volcanic rock or material, sand, aggregate (e.g., fine aggregate, coarse aggregate, intermediate aggregate, other types of aggregate, etc.), lightweight aggregate, talc, other clay material, fibers (e.g., steel and/or other metallic fibers, polypropylene and/or other polymeric fibers, glass fibers, asbestos fibers, carbon fibers, organic fibers, etc.), glass fiber reinforced plastic (GFRP), other reinforced polymers, admixtures or other additives that facilitate with fire protection, water protection, corrosion resistance/inhibition, workability, and/or one more other properties of the final cured product (e.g., MasterPel, RheoCell, MasterCell, etc.), sodium naphthalene sulfonate formaldehyde (SNF) and/or other surfactants, plasticizers, pigments, dyes and other color additives, titanium dioxide, other minerals, other natural or synthetic materials, other filler materials and/or the like. In embodiments, fillers and/or other additives include, but are not limited to, non-cementitious slags (e.g., air-cooled slags or arc furnace slags), non-Class C fly ash (e.g., Class F fly ash), silica fume, nanosilica, fine silica glass, other silica-based materials, waste glass, ground glass, other glass-containing materials, post-consumer materials, other waste materials, fine aggregate, intermediate aggregate, coarse aggregate, other types of aggregate, pumice or other volcanic rock or material. In some embodiments, the fillers and/or other additives are included to react with the other components of the mix and/or to provide some beneficial characteristic or property to the resulting paste (e.g., once the mix is combined with water) and/or the final cured product. For example, in some embodiments, such materials (e.g., air-cooled slags, other non-cementitious slags, Class F fly ash, other non-cementitious fly ash, pozzolan, silica fume, etc.) can act to reduce the permeability of the resulting paste or cured product. In some embodiments, such materials help plug or otherwise fill holes or other cavities in the resulting paste and cured product. According to some arrangements, mixes or formulations that include materials that provide one or more benefits or other advantages to the resulting paste or cured product can be referred to as ternary mixes. In some embodiments, the non-cementitious components included in a ternary mix satisfy the requirements of ASTM C595. In some embodiments, fillers and/or other additives are included to provide one or more other benefits and advantages, either in addition to or in lieu of reducing permeability. For instance, one or more additives listed above can facilitate with fire protection, water protection, corrosion resistance/inhibition, workability, and/or one more other properties of the final cured product. In some embodiments, fillers such as aggregate (e.g., coarse aggregate, intermediate aggregate, fine aggregate, etc.), clay, pumice or other volcanic rock or material, sand, talc, other clay material, etc. are there merely as fillers. Such materials can provide the mix and the resulting paste and cured product with the desired or required density and structural properties.

In embodiments for the cementitious mixture, the amount of natural pozzolan and granulated ground blast furnace slag in the formulation by weight % can be relatively equal to one another. For example, the amount of natural pozzolan to granulated ground blast furnace slag can range in a ratio from about 75:25 to about 25:75. In embodiments, the ratio of natural pozzolan to granulated ground blast furnace slag is 75:25, 70:30, 65:35, 60:40, 59:41, 58:42, 57:43, 56:44, 55:45, 54:46, 53:47, 52:48, 51:49, 50:50, 49:51, 48:52, 47:53, 46:54, 45:55, 44:56, 43:57, 42:58, 41:59, 40:60, 35:65, 30:70, or 25:75.

In embodiments for the cementitious mixture, the amount of natural pozzolan and manmade pozzolan in the formulation by weight % can be relatively equal to one another. For example, the amount of natural pozzolan to manmade pozzolan can range in a ratio from about 75:25 to about 25:75. In embodiments, the ratio of natural pozzolan to manmade pozzolan is 75:25, 70:30, 65:35, 60:40, 59:41, 58:42, 57:43, 56:44, 55:45, 54:46, 53:47, 52:48, 51:49, 50:50, 49:51, 48:52, 47:53, 46:54, 45:55, 44:56, 43:57, 42:58, 41:59, 40:60, 35:65, 30:70, or 25:75.

In embodiments, the amount of natural pozzolan relative to the amount of ground-granulated blast-furnace slag ranges from about 33 wt. % to about 300 wt. %. In some embodiments, the amount of natural pozzolan present relative to the amount of ground granulated blast-furnace slag ranges from about 50 wt. % to about 200 wt. %. In embodiments, the amount of natural pozzolan present relative the amount of ground granulated blast-furnace slag ranges from about 85 wt. % to about 115 wt. %. In some embodiments, the amount of natural pozzolan present relative to the amount of ground granulated blast-furnace slag ranges from about 90 wt. % to about 110 wt. %. In embodiments, the amount of natural pozzolan present relative to the amount of ground granulated blast-furnace slag is 33 wt. %, 34 wt. %, 35 wt. %, 40 wt. %, 45 wt. %, 50 wt. %, 55 wt. %, 60 wt. %, 65 wt. %, 70 wt. %, 75 wt. %, 80 wt. %, 85 wt. %, 90 wt. %, 95 wt. %, 100 wt. % 105 wt. %, 110 wt. %, 115 wt. %, 120 wt. %, 125 wt. %, 130 wt. %, 135 wt. %, 140 wt. %, 145 wt. %, 150 wt. %, 165 wt. %, 170 wt. %, 175 wt. %, 180 wt. %, 185, 190 wt. %, 195 wt. %, 200 wt. %, 205 wt. %, 210 wt. %, 215 wt. %, 220 wt. %, 230 wt. %, 235 wt. %, 240 wt. %, 245 wt. %, 250 wt. %, 265 wt. %, 270 wt. %, 275 wt. %, 280 wt. %, 285 wt. %, 290 wt. %, 295 wt. %, 300 wt. %; or any sub-value or subrange between 33% wt. % and 300 wt. %.

In embodiments, the amount of natural pozzolan relative to the amount of manmade pozzolan ranges from about 33 wt. % to about 300 wt. %. In some embodiments, the amount of natural pozzolan present relative to the amount of manmade pozzolan ranges from about 50 wt. % to about 200 wt. %. In embodiments, the amount of natural pozzolan present relative the amount of manmade pozzolan ranges from about 85 wt. % to about 115 wt. %. In some embodiments, the amount of natural pozzolan present relative to the amount of manmade pozzolan ranges from about 90 wt. % to about 110 wt. %. In embodiments, the amount of natural pozzolan present relative to the amount of manmade pozzolan is 33 wt. %, 34 wt. %, 35 wt. %, 40 wt. %, 45 wt. %, 50 wt. %, 55 wt. %, 60 wt. %, 65 wt. %, 70 wt. %, 75 wt. %, 80 wt. %, 85 wt. %, 90 wt. %, 95 wt. %, 100 wt. % 105 wt. %, 110 wt. %, 115 wt. %, 120 wt. %, 125 wt. %, 130 wt. %, 135 wt. %, 140 wt. %, 145 wt. %, 150 wt. %, 165 wt. %, 170 wt. %, 175 wt. %, 180 wt. %, 185, 190 wt. %, 195 wt. %, 200 wt. %, 205 wt. %, 210 wt. %, 215 wt. %, 220 wt. %, 230 wt. %, 235 wt. %, 240 wt. %, 245 wt. %, 250 wt. %, 265 wt. %, 270 wt. %, 275 wt. %, 280 wt. %, 285 wt. %, 290 wt. %, 295 wt. %, 300 wt. %; or any sub-value or subrange between 33% wt. % and 300 wt. %.

In embodiments, the amount of nitrate present relative to the amount of manmade pozzolan, e.g. ground-granulated blast furnace slag ranges from about 2 wt. % to about 30 wt. %. In embodiments, the amount of nitrate present relative to the amount of manmade pozzolan, e.g. ground-granulated blast furnace slag ranges from about 2 wt. % to about 12 wt. %. In embodiments, the amount of nitrate present relative to the amount of manmade pozzolan, e.g. ground-granulated blast furnace slag ranges from about 15 wt. % to about 30 wt. %. In embodiments, the amount of nitrate present relative to the amount of manmade pozzolan, e.g. ground-granulated blast furnace slag is about 2 wt. %, 3 wt. %, 4 wt. %, 5 wt. %, 6 wt. %, 7 wt. %, 8 wt. %, 9 wt. %, 10 wt. %, 11 wt. %, 12 wt. %, 13 wt. %, 14 wt. %, 15 wt. %, 16 wt. %, 17 wt. %, 18 wt. %, 19 wt. %, 20 wt. %, 21 wt. %, 22 wt. %, 23 wt. %, 24 wt. %, 25 wt. %, 26 wt. %, 27 wt. %, 28 wt. %, 29 wt. %, or 30 wt. %.

In embodiments, the amount of sulfate present relative to the amount of manmade pozzolan, e.g. ground-granulated blast-furnace slag ranges from about 0.1 wt. % to about 90 wt. %. In embodiments, the amount of sulfate present relative to the amount of manmade pozzolan, e.g. ground-granulated blast-furnace slag ranges from about 20 wt. % to about 110 wt. %. In embodiments, the amount of sulfate present relative to the amount of manmade pozzolan, e.g. ground-granulated blast-furnace slag ranges from about 20 wt. % to about 50 wt. %. In embodiments, the amount of sulfate present relative to the amount of manmade pozzolan, e.g. ground-granulated blast-furnace slag ranges from about 80 wt. % to about 110 wt. %. In embodiments, the amount of sulfate present relative to the amount of manmade pozzolan, e.g. ground-granulated blast-furnace slag is about 0.1 wt. %, 0.2 wt. %, 0.3 wt. %, 0.4 wt. %, 0.5 wt. %, 0.6 wt. %, 0.7 wt. %, 0.8 wt. %, 0.9 wt. %, 1 wt %, 2 wt. %, 3 wt. %, 4 wt. %, 5 wt. %, 6 wt. %, 7 wt. %, 8 wt. %, 9 wt. %, 10 wt. %, 11 wt. %, 12 wt. %, 13 wt. %, 14 wt. %, 15 wt. %, 16 wt. %, 17 wt. %, 18 wt. %, 19 wt. %, 20 wt. %, 30 wt. %, 40 wt. %, 50 wt. %, 60 wt. %, 70 wt. %, 80 wt. %, 90 wt. %, 100 wt. %, 110 wt. %; or subintegers thereof, including ranges between endpoints. For example, in embodiments, the amount of sulfate present relative to the amount of slag, e.g. ground-granulated blast-furnace slag is 31 wt. %. In other embodiments, the amount of sulfate present relative to the amount of slag, e.g. ground-granulated blast-furnace slag is 90 wt. %.

In embodiments, the amount of chloride present relative to the amount of manmade pozzolan, e.g. ground-granulated blast-furnace slag ranges from about 0.1 wt. % to about 12 wt. %. In embodiments, the amount of chloride is dependent on the end use and the size of the batch. Without being bound to any one theory, the use of chloride assists with the density of the batch. In embodiments, the amount of chloride present relative to the amount of manmade pozzolan, e.g. ground-granulated blast-furnace slag is about 0.1 wt. %, 0.2 wt. %, 0.3 wt. %, 0.4 wt. %, 0.5 wt. %, 0.6 wt. %, 0.7 wt. %, 0.8 wt. %, 0.9 wt. %, 1.0 wt. %, 1.1 wt. %, 1.2 wt. %, 1.3 wt. %, 1.4 wt. %, 1.5 wt. %, 1.6 wt. %, 1.7 wt. %, 1.8 wt. %, 1.9 wt. %, 2 wt. %, 3 wt. %, 4 wt. %, 5 wt. %, 6 wt. %, 7 wt. %, 8 wt. %, 9 wt. %, 10 wt. %, 11 wt. %, 12 wt. %; or subintegers thereof. For example, in embodiments, the amount of chloride present relative to the amount of slag, e.g. ground-granulated blast-furnace slag is 1.8 wt. %.

In embodiments, the amount of phosphate present relative to the amount of manmade pozzolan, e.g. ground-granulated blast-furnace slag ranges from about 0.1 wt. % to about 20 wt. %. In embodiments, the amount of phosphate present relative to the amount of manmade pozzolan, e.g. ground-granulated blast-furnace slag is about 0.1 wt. %, 0.2 wt. %, 0.3 wt. %, 0.4 wt. %, 0.5 wt. %, 0.6 wt. %, 0.7 wt. %, 0.8 wt. %, 0.9 wt. %, 1.0 wt. %, 1.1 wt. %, 1.2 wt. %, 1.3 wt. %, 1.4 wt. %, 1.5 wt. %, 1.6 wt. %, 1.7 wt. %, 1.8 wt. %, 1.9 wt. %, 2 wt. %, 3 wt. %, 4 wt. %, 5 wt. %, 6 wt. %, 7 wt. %, 8 wt. %, 9 wt. %, 10 wt. %, 11 wt. %, 12 wt. %, 13 wt. %, 14 wt. %, 15 wt. %, 16 wt. %, 17 wt. %, 18 wt. %, 19 wt. %, 20 wt. %; or subintegers thereof.

In aspects, a proportion by weight of pozzolan is 80% to 120% of a proportion of reactants by weight of the mixture. In an aspect, a sum of the proportions of reactants and the pozzolan(s) comprises at least 12% by weight of the mixture. In embodiments, the sum of the proportions of the reactant(s) and the natural pozzolan(s) or pozzolan(s) is 15% to 50% (e.g., 15%-50%, 15%-45%, 15-40%, 15%-35%, 20%-50%, 20%-45%, 20%-40%, 20%-35%, 25%-50%, 25%-45%, 25%-40%, 25%-35%, 25%-30%, 30%-35%, values between the foregoing ranges, etc.) by weight of the mixture, and wherein the proportion by weight of the natural pozzolan(s) or pozzolan(s) is 90% to 110% of the proportion of reactant(s) by weight of the mixture. In an aspect, the sum of the proportions of reactant(s) and the natural pozzolan(s) and/or pozzolan(s) is 40% to 70% by weight of the mixture. In some embodiments, the proportion by weight of the natural pozzolan(s) and/or pozzolan(s) is 90% to 110% of the proportion of reactant(s) by weight of the mixture.

In an aspect, a proportion by weight of the at least one accelerant is 10% to 70% (e.g., 10%-70%, 10%-65%, 10%-60%, 10%-55%, 10%-50%, 10%-45%, 10%-40%, 10%-35%, 20%-50%, 20%-45%, 20%-40%, 20%-35%, 25%-50%, 25%-45%, 25%-40%, 25%-35%, 25%-30%, 30%-35%, values between the foregoing ranges, etc.) of the proportion of reactant(s) by weight of the mixture.

In embodiments, the present application contemplates multiple end uses for the concrete-replacement material. Those uses include, but are not limited to, building construction both residential and commercial (e.g., used in columns, beams and other load-bearing members), walls and other construction panels (e.g., including non-load bearing members), airports, dams, levees, bridges, tunnels, harbors, refineries and other industrial sites, parking structures, roadways, sidewalks, tile and other flooring, pavers, planters, homeware, pipes, channels, countertops and/or the like. Depending on final cured product's ability to not damage steel or other metals, one or more of formulations or mixes are suitable for use in applications tensile reinforcement is desired or required (e.g., to prevent or reduce the likelihood of cracking, breaking and/or other compromising occurrence to the cured product.) Uses of the present application also contemplate pre-cast materials such as panels for buildings. Other non-structural uses of the present application provided herein may be kitchen islands, decorative garden structures (e.g., birdbaths, benches, planters, pots, etc.), tiles, decorative floors, furniture, bathroom tubs, sinks, tables, hearth, basins, pool deck, or any architectural or decorative application where a concrete-material may be used.

According to some embodiments, a cementitious mixture that results from combining any of the mixtures disclosed herein with water comprises a density that is equal or substantially equal to the density of Portland cement pastes. In some embodiments, the density of the cementitious mixture is 80% to 120% (e.g., 80%-120%, 90%-110%, 95%-105%, 98%-102%, 80%-100%, 85%-100%, 90%-100%, 95%-100%, 80%-90%, 85%-95%, 100%-120%, 100%-115%, 100%-110%, 100%-105%, 105%-115%, 105%-120%, values between the foregoing ranges, etc.) of the density of Portland cement pastes.

Further, according to some embodiments, a cementitious mixture that results from combining any of the mixtures disclosed herein with water comprises a rate of leaching that is equal to substantially equal to a rate of leaching of Portland cement pastes. In some embodiments, the rate of leaching of the cementitious mixture is 80% to 120% of the rate of leaching of Portland cement pastes. According to some embodiments, for one or more of the mix configurations disclosed herein, the rate of leaching of components (MgCl₂, Mg(NO₃)₂, MgSO₄, hydrous, anhydrous and/or other compounds having the same, etc.), during and/or following cure, is equal to or lower relative to the rate of leaching in known cements (e.g., Portland cements, MgO or other magnesia cements, etc.). In some embodiments, the rate of leaching by mass can be lower by 0%-10% (e.g., 0-10, 0-5, 2-8, 2-10, 5-10, 2-5, 5-8, 1-9%, percentages between the foregoing ranges, etc.) relative to known cements. In some embodiments, the rate of leaching for one or more of the mix configurations disclosed herein is equal or substantially equal of the rate of leaching of known cements (e.g., Portland cements, MgO or other magnesia cements, etc.). In other arrangements, however, the rate of leaching by mass can be lower by more than 10% (e.g., 10-15, 15-20, 20-30%, greater than 30%, etc.).

Also, according to some embodiments, a cementitious mixture that results from combining any of the mixtures disclosed herein with water comprises a modulus of elasticity that is equal to substantially equal to the modulus of elasticity of Portland cement pastes. According to some embodiments, a cementitious mixture that results from combining any of the mixtures disclosed herein with water comprises a modulus of elasticity that is equal to substantially equal to the modulus of elasticity of Portland cement pastes. In some embodiments, the modulus of elasticity of the cementitious mixture is 50% to 200% (e.g., 50-200, 50-190, 50-180, 50-170, 50-160, 50-150, 50-140, 50-130, 50-120, 50-110, 50-100, 50-90, 50-80, 50-70, 50-60, 60-200, 60-190, 60-180, 60-170, 60-160, 60-150, 60-140, 60-130, 60-120, 60-110, 60-100, 60-90, 60-80, 60-70, 70-200, 70-190, 70-180, 70-170, 70-160, 70-150, 70-140, 70-130, 70-120, 70-110, 70-100, 70-90, 70-80, 80-200, 80-190, 80-180, 80-170, 80-160, 80-150, 80-140, 80-130, 80-120, 80-110, 80-100, 80-90, 90-200, 90-190, 90-180, 90-170, 90-160, 90-150, 90-140, 90-130, 90-120, 90-110, 90-100, 100-200, 100-190, 100-180, 100-170, 100-160, 100-150, 100-140, 100-130, 100-120, 100-110, 110-200, 110-190, 110-180, 110-170, 110-160, 110-150, 110-140, 110-130, 110-120, 120-200, 120-190, 120-180, 120-170, 120-160, 120-150, 120-140, 120-130, 130-200, 130-190, 130-180, 130-170, 130-160, 130-150, 130-140, 140-200, 140-190, 140-180, 140-170, 140-160, 140-150, 150-200, 150-190, 150-180, 150-170, 150-160, 160-200, 160-190, 160-180, 160-170, 170-200, 170-190, 170-180, 180-200, 180-190, 190-200, 95-105, 85-115, 75-125, 65-135, 55-145, values between the foregoing values and ranges, etc.) of the modulus of elasticity of Portland cement pastes. In some embodiments, the modulus of elasticity of a cementitious mixture that results from combining any of the mixtures disclosed herein with water is 3(106) to 5(106) (e.g., 3(106) to 5(106), 3.0(106) to 3.5(106), 3.5(106) to 4.0(106), 4.0(106) to 4.5(106), 4.5(106) to 5.0(106), 3(106) to 4(106), 3.0(106) to 4.5(106), 3.5(106) to 5.0(106), 3.5(106) to 4.5(106), 3.0(106), 3.1(106), 3.2(106), 3.3(106), 3.4(106), 3.5(106), 3.6(106), 3.7(106), 3.8(106), 3.9(106), 4.0(106), 4.1(106), 4.2(106), 4.3(106), 4.4(106), 4.5(106), 4.6(106), 4.7(106), 4.8(106), 4.9(106), 5.0(106) psi, values between the foregoing values and ranges, etc.) psi.

In addition, according to some embodiments, a curable paste that results from combining any of the mixtures disclosed herein with water comprises a Poisson's Ratio that is equal to substantially equal to Poisson's Ratio of Portland cement pastes. In some embodiments, the Poisson's Ratio of the curable paste is 70% to 150% (e.g., 70%-150%, 70%-140%, 70%-130%, 70%-120%, 70%-110%, 70%-100%, 70%-90%, 70%-80%, 80%-150%, 80%-140%, 80%-130%, 80%-120%, 80%-110%, 80%-100%, 80%-90%, 90%-150%, 90%-140%, 90%-130%, 90%-120%, 90%-110%, 90%-100%, 100%-150%, 100%-140%, 100%-130%, 100%-120%, 100%-110%, 110%-150%, 110%-140%, 110%-130%, 110%-120%, 120%-150%, 120%-140%, 120%-130%, 130%-150%, 130%-140%, 140%-150%, 95%-105%, 85%-115%, 75%-125%, percentages between the foregoing ranges, etc.) of the Poisson's ratio of Portland cement pastes. In some embodiments, the Poission's Ratio of a curable paste that results from combining any of the mixtures disclosed herein with water is 0.15 to 0.30 (e.g., 0.15, 0.16, 0.17, 0.18, 0.19, 0.20, 0.21, 0.22, 0.23, 0.24, 0.25, 0.15-0.25, 0.15-0.20, 0.25-0.30, 0.20-0.25, 0.20-0.27, 0.20-0.30, values between the foregoing values and ranges, etc.).

### III. Methods

In an aspect, provided herein is a manufacturing process of a negative-carbon dioxide-emitting concrete-replacement material production process and/or product comprising (a) mixing a slurry comprising water, natural pozzolan, nitrate, sulfate, sodium, chloride, and/or phosphate with granulated ground blast furnace slag to form a cementitious mixture; (b) pouring the cementitious mixture into a structural component mold to form a poured cementitious mixture; and then (c) curing the poured cementitious mixture from step (b) in the structural mold to form a negative carbon dioxide-emitting concrete-replacement material. In an aspect, provided herein is a manufacturing process of a negative-carbon dioxide-emitting concrete-replacement material production process and/or product comprising (a) mixing a slurry comprising water, natural pozzolan, nitrate, sulfate, sodium, chloride, and/or phosphate with manmade pozzolan to form a cementitious mixture; (b) pouring the cementitious mixture to form a poured cementitious mixture; and then (c) curing the poured cementitious mixture from step (b) to form a negative carbon dioxide-emitting concrete-replacement material. In an aspect, provided herein is a manufacturing process of a negative-carbon dioxide-emitting concrete-replacement material production process and/or product comprising (a) mixing a slurry comprising water, pozzolan, nitrate, sulfate, sodium, chloride, and/or phosphate with MgO to form a cementitious mixture; (b) pouring the cementitious mixture to form a poured cementitious mixture; and then (c) curing the poured cementitious mixture from step (b) to form a negative carbon dioxide-emitting concrete-replacement material. In an aspect, provided herein is a manufacturing process of a negative-carbon dioxide-emitting concrete-replacement material production process and/or product comprising (a) mixing a slurry comprising water, pozzolan, nitrate, sulfate, sodium, chloride, and/or phosphate with Mg(OH)₂ to form a cementitious mixture; (b) pouring the cementitious mixture to form a poured cementitious mixture; and then (c) curing the poured cementitious mixture from step (b) to form a negative carbon dioxide-emitting concrete-replacement material.

In an aspect, provided herein is a manufacturing process of a negative carbon dioxide-emitting artificial, stonelike material production process and/or product comprising (a) mixing a slurry comprising water, natural pozzolan, nitrate, sulfate, sodium, chloride, and/or phosphate with granulated ground blast furnace slag to form a cementitious mixture; (b) pouring the cementitious mixture into a structural component mold to form a poured cementitious mixture; and then (c) curing the poured cementitious mixture from step (b) in the structural mold to form a negative-carbon dioxide emitting artificial, stonelike material. In an aspect, provided herein is a manufacturing process of a negative carbon dioxide-emitting artificial, stonelike material production process and/or product comprising (a) mixing a slurry comprising water, natural pozzolan, nitrate, sulfate, sodium, chloride, and/or phosphate with manmade pozzolan to form a cementitious mixture; (b) pouring the cementitious mixture to form a poured cementitious mixture; and then (c) curing the poured cementitious mixture from step (b) to form a negative-carbon dioxide emitting artificial, stonelike material. In an aspect, provided herein is a manufacturing process of a negative carbon dioxide-emitting artificial, stonelike material production process and/or product comprising (a) mixing a slurry comprising water, pozzolan, nitrate, sulfate, sodium, chloride, and/or phosphate with MgO to form a cementitious mixture; (b) pouring the cementitious mixture to form a poured cementitious mixture; and then (c) curing the poured cementitious mixture from step (b) to form a negative-carbon dioxide emitting artificial, stonelike material. In an aspect, provided herein is a manufacturing process of a negative carbon dioxide-emitting artificial, stonelike material production process and/or product comprising (a) mixing a slurry comprising water, pozzolan, nitrate, sulfate, sodium, chloride, and/or phosphate with Mg(OH)₂ to form a cementitious mixture; (b) pouring the cementitious mixture to form a poured cementitious mixture; and then (c) curing the poured cementitious mixture from step (b) to form a negative-carbon dioxide emitting artificial, stonelike material.

In another aspect, contemplated herein is a manufacturing process of a negative carbon dioxide-emitting artificial, stonelike material wall or slab. In embodiments, the process may comprise, but is not limited to, (1) extrusion with a clay extruder through a die into the final shape of the wall or slab; (2) extrusion with a clay extruder through a die into a sheet of thickness equal to or bigger than the final thickness of the wall or slab and a width that allows for the width of one or multiple wall or slab. The sheet is formed into the shape of the final wall or slab either by placing the sheet over a bottom mold half in a vertical press or running the sheet through forming calendars; (3) extruding cylindrical pieces of material that are subsequently formed into the final wall or slab shape between bottom and top molds in a vertical press or similar; or (4) by mixing the rheologically modified material and placing finite metered pieces of the material that are subsequently formed into the final wall or slab between bottom and top molds in a vertical press or similar.

In embodiments, any one of the preceding methods may be followed by setting within a couple of hours. In embodiments, setting occurs within about 2 hours to about 48 hours.

In embodiments, the mechanical properties are modified to generate a ductile (non-brittle) material by the addition of fiber reinforcement such as cellulose fiber, glass fiber, plastic fiber, polypropylene fiber, polyvinyl alcohol (PVA) fiber, homopolymer acrylic or alkali-resistant fiber, natural fiber, or a combination thereof.

In embodiments, the artificial, stonelike material tiles can be made water resistant by including in the mix of the product to a water repellent silane and/or an oil repellant silane or applying on the water resistant surface coating known in state-of-the-art.

### Examples

The examples provided herein comprise compositions of cementitious materials comprising natural pozzolan and manmade pozzolan, e.g. granulated ground blast furnace slag, and/or MgO or Mg(OH)₂. It should be understood to one in skill in the art that the example compositions are non-limiting and may be adjusted based on factors such as heat and humidity to achieve properties such as compressive strength, flexural strength, modulus of elasticity, low deterioration, and absorption of CO₂ contemplated by the present application. The application and examples illustrate that the result-effective variables to achieve these properties include sulfate, nitrate, chloride and pozzolan, e.g. natural pozzolan.

### Materials and Methods.

TABLE 1
Composition A

| | Proportion (by weight of dry mix) |
|---|---|
| Component | relative to 400 lbs of GGBFS |
| basalt | 85%-115% |
| GGBFS | — |
| sand | |
| 1 inch nominal | |
| #86 intermediate | |
| MgCl₂*H₂O | 0.0%-5% |
| MgSO₄*7H₂O | 20%-40% |
| MgNO₃*6H₂O | 2-12% |
| high range water reducer | 0%-10% |

TABLE 2
Properties of Composition A

| Property | Value |
|---|---|
| 1- day strength of curing | >1000 psi |
| 7 - day strength of curing | >3000 psi |
| 28-day strength of curing | >5000 psi |

TABLE 3
Composition B

| | Proportion (by weight of dry mix) | |
|---|---|---|
| Component | relative to 2200 lbs of GGBFS | |
| basalt | 85%-115% | |
| GGBFS | — | |
| sand | | |
| 67 aggregate | | |
| 8 aggregate | | |
| MgCl₂*H₂O | 1.8% | (0.1%-5%) |
| MgSO₄*7H₂O | 90% | (80%-110%) |
| MgNO₃*6H₂O | 23% | (15-30%) |

| | |
|---|---|
| high range water reducer | 0%-10% |
| phosphate | 0%-20% |

TABLE 4
Properties of Composition B

| Property | Value |
|---|---|
| 1- day strength of curing | >1000 psi |
| 7 - day strength of curing | >3000 psi |
| 28-day strength of curing | >4000 psi |

TABLE 5
Composition C with brine

| Component | Amount by weight % |
|---|---|
| (basalt + GGBFS) | 10%-50% |
| brine | 5%-25% |
| high range H₂O reducer | 0%-5% |
| aggregates | 20%-90% |
| Total | 100% |

TABLE 6
Composition D

| | Proportion (by weight of dry mix) |
|---|---|
| Component | relative to pozzolan |
| pozzolan | — |
| MgO | 85%-115% |
| sand | |
| 1 inch nominal | |
| #86 intermediate | |
| MgCl₂*6H₂O | 0.0%-5% |
| MgSO₄*7H₂O | 20%-40% |
| MgNO₃*6H₂O | 2-12% |
| high range water reducer | 0%-10% |

TABLE 7
Properties of Composition D

| Property | Value |
|---|---|
| 1- day strength of curing | >1000 psi |
| 7 - day strength of curing | >3000 psi |
| 28-day strength of curing | >4000 psi |

TABLE 8
Composition E

| | Proportion (by weight of dry mix) |
|---|---|
| Component | relative to 400 lbs of GGBFS |
| Mg(OH)₂ (binder) | 85%-115% |
| GGBFS (binder) | — |
| 0-3 mm aggregate | |
| 8-12 mm aggregate | |
| MgCl₂*6H₂O | 0.0%-5% |
| MgSO₄*7H₂O | 20%-40% |
| MgNO₃*6H₂O | 2-12% |
| high range water reducer | 0%-10% |
| Total proportion of binder | 35%-40% |
| in total dry mix (A) | |
| Total proportion of aggregates | 60%-65% |
| in total dry mix (B) | |

Note:
(A) + (B) = 100%

TABLE 9
Properties of Composition E

| Property | Value |
|---|---|
| 1- day strength of curing | — |
| 7 - day strength of curing | >3000 psi |
| 28-day strength of curing | >4000 psi |

TABLE 10
Composition F

| | Proportion (by weight of dry mix) |
|---|---|
| Component | relative to 400 lbs of GGBFS |
| Basalt (binder) | 85%-115% |
| GGBFS (binder) | — |
| 0-3 mm aggregate | |
| 8-12 mm aggregate | |
| MgCl₂*6H₂O | 0.0%-5% |
| MgSO₄*7H₂O | 20%-40% |
| MgNO₃*6H₂O | 2-12% |
| high range water reducer | 0%-10% |
| Total proportion of binder | 30%-40% |
| in total dry mix (A) | |
| Total proportion of aggregates | 60%-70% |
| in total dry mix (B) | |

Note:
(A) + (B) = 100%

TABLE 11
Properties of Composition F

| Property | Value |
|---|---|
| 1- day strength of curing | — |
| 7 - day strength of curing | — |
| 28-day strength of curing | >4000 psi |

TABLE 12
Composition G

| | Proportion (by weight of dry mix) |
|---|---|
| Component | relative to 400 lbs of GGBFS |
| 62% Brucite (binder) | 85%-115% |
| GGBFS (binder) | — |
| 0-3 mm aggregate | |
| 8-12 mm aggregate | |
| MgCl₂*6H₂O | 0.0%-5% |
| MgSO₄*7H₂O | 20%-40% |
| high range water reducer | 0%-10% |
| Total proportion of binder | 35%-40% |
| in total dry mix (A) | |
| Total proportion of aggregates | 60%-65% |
| in total dry mix (B) | |

Note:
(A) + (B) = 100%

TABLE 13
Properties of Composition G

| Property | Value |
|---|---|
| 1- day strength of curing | — |
| 7 - day strength of curing | >3000 psi |
| 28-day strength of curing | >3000 psi |

TABLE 14
Composition H

| | Proportion (by weight of dry mix) |
|---|---|
| Component | relative to 400 lbs of GGBFS |
| [MgO + basalt] (binder) | 85%-115% |
| GGBFS (binder) | — |
| 0-3 mm aggregate | |
| 8-12 mm aggregate | |
| MgCl₂*6H₂O | 0.0%-5% |
| MgSO₄*7H₂O | 20%-40% |
| MgNO₃*6H₂O | 2-12% |
| high range water reducer | 0%-10% |
| Total proportion of binder | 35%-40% |
| in total dry mix (A) | |
| Total proportion of aggregates | 60%-65% |
| in total dry mix (B) | |

Note:
(A) + (B) = 100%

TABLE 15
Properties of Composition H

| Property | Value |
|---|---|
| 1- day strength of curing | >3000 psi |
| 7 - day strength of curing | >4000 psi |
| 28-day strength of curing | >5000 psi |

Comparative Strength. The compressive strength of concrete is measured after 3, 7, 14, 28, 56, 90 and 180 days of curing on 50 mm cube specimens in accordance with ASTM C109 using a digital compression machine [ASTM C109-10, Standard Test Method for Compressive Strength of Hydraulic Cement Mortars (Using 2-in. or [50-mm] Cube Specimens), ASTM International, West Conshohocken, Pa., 2010]. The specimens are retrieved from the oven after each curing period and allowed to cool down prior to testing. Triplicate specimens for each curing period are prepared and tested under compression. The average value of three readings is reported.

As contemplated herein, the 1-day strength of the mixture once combined with water and permitted to cure is at least 1000 psi, 1500 psi, 2000 psi, 2500 psi, 3000 psi, 3500 psi, 4000 psi, 4500 psi, 5000 psi, 5500 psi, 6000 psi, 6500 psi, 7000 psi, 7500 psi, 8000 psi, 8500 psi, 9000 psi or greater, including any value or subrange within the recited ranges, including endpoints. In some embodiments, the 7-day strength of the mixture once combined with water and permitted to cure is at least 1000 psi, 1500 psi, 2000 psi, 2500 psi, 3000 psi, 3500 psi, 4000 psi, 4500 psi, 5000 psi, 5500 psi, 6000 psi, 6500 psi, 7000 psi, including any value or subrange within the recited ranges, including endpoints. In some embodiments, the 28-day strength of the mixture once combined with water and permitted to cure is at least 1000 psi, 1500 psi, 2000 psi, 2500 psi, 3000 psi, 3500 psi, 4000 psi, 4500 psi, 5000 psi, 5500 psi, 6000 psi, 6500 psi, 7000 psi, including any value or subrange within the recited ranges, including endpoints.

Flexural Strength. Prismatic specimens measuring 50×50×200 mm are prepared to determine the flexural strength of concrete using third point loading in accordance with ASTM C78 [ASTM C1437-10, Standard Specification for Coal Fly Ash and Raw or Calcined Natural Pozzolan for Use in Concrete, ASTM International, West Conshohocken, Pa., 2010; ASTM C78-10, Standard Test Method for Flexural Strength of Concrete (Using Simple Beam with Third-Point Loading), ASTM International, West Conshohocken, Pa., 2010]. The flexural strength of concrete was determined at 28 and 90 days of curing. Triplicate specimens of each mix for a particular curing period were prepared and tested. The average value of three readings is reported.

Modulus of Elasticity. The modulus of elasticity of concrete is measured on 75 mm diameter and 150 mm high cylindrical concrete specimens. The experiment is conducted in accordance with ASTM C 469 [ASTM C496-10, Standard Test Method for Splitting Tensile Strength of Cylindrical Concrete Specimens, ASTM International, West Conshohocken, Pa., 2010]. The modulus of elasticity is measured after 28 and 90 days of curing.

### Environmental Impact

The present application contemplates producing a housing structure made with housing material that meets current shortages in housing while generating carbon credits. In embodiments, the housing structure is made with negative-carbon dioxide emitting cementitious material. In further embodiments, the negative-carbon dioxide emitting cementitious material is a cementitious masonry unit manufactured by the processes described herein. The production of the cementitious masonry unit (block) provided herein absorbs carbon dioxide and has reduced output of carbon dioxide based on the methods of making. In some embodiments, the production does not require fresh water.

Each masonry unit is 0.0076 m³ volume of cementitious material, which weighs 38.5 lb (17.5 kg). Upon testing, the negative-carbon dioxide emitting cementitious material absorbs 32 kg CO₂/m.t./yr (m.t. refers to metric tons). Therefore, for each block over a 20 year period:

17.5 kg×0.001 m.t./kg×32 kg CO₂/m.t./yr×20 yrs=11.2 kg CO₂/block over 20 years

Each block also produces less carbon dioxide than conventional concrete and other cement products:

0.0076 m³×405 kg CO₂/m³=3.08 kg of CO₂ avoided per block

Therefore, the total carbon credit (avoidance is 11.2 kg CO₂/block+removal is 3.1 kg CO₂/block) is 14.3 kg (31.5 lb) CO₂/block. Note: 405 kg CO₂/m³ is based on DuPont EPD High Test CMU 900003403, issued Aug. 31, 2021 valid through Aug. 31, 2026 (www.basalite-cmu.com/_files/ugd/31fd52_c399e811721a4fa4b9fe9cf4bd91c2e6.pdf)

The above calculation is then converted to an application calculation where the cementitious masonry block is combined with mortar (or a filling).

Carbon Removal, 22.6 kg (49.8 lb): 11.2 kg CO₂/block (calculation from above)+11.4 kg (mortar/filling)

11.2 kg CO₂/block+[mortar/filling] 11.2 kg CO₂/block×1.02 kg mortar/kg block=22.6 kg CO₂

Carbon Avoidance, 6.22 kg (13.7 lb): 3.08 kg (calculation from above)+3.14 kg (mortar)

3.08 kg (block)+3.08 kg CO₂/block×1.02 kg mortar/kg block=6.22 kg CO₂

Total Carbon Credit (Removal is 22.6 kg CO₂+Avoidance is 6.22 kg CO₂) is 28.8 kg CO₂ (63.5 lb) per block.

The environmental impact of the materials contemplated herein extends to the consumption of fresh water, wherein the compositions of the present application do not utilize fresh or treated water in the manufacturing process. According to the U.S. EPA (https://www.epa.gov/indoor-air-quality-iaq/introduction-indoor-air-quality), carbon dioxide absorption equivalence for a medium-growth coniferous tree allowed to grow for 10 years is 23.2 lb of CO₂ (10.5 kg). Accordingly, referring to the calculations above, each cementitious masonry unit removes 11.2 kg of CO₂, which is approximately equivalent to 1 tree. For each applied cementitious masonry unit, referring to the calculations above, 20.4 kg of CO₂ are removed, which is equivalent to two trees.

In embodiments of the compositions provided herein, the cementitious masonry unit is used for the construction of a house. In embodiments, the size of the house is 1,250 ft². Each house uses 3,000 applied cementitious masonry units. In addition to the mortar and filling material for the applied blocks, each home includes 62.9 m³ of cementitious material in the foundation, slab, porch, roof tiles, driveway, and sidewalks. Using the density of the material, 1,505 kg/m³ (or 94 lb/ft³), 32 kg of CO₂/metric ton/year is absorbed. In embodiments, the present application avoids the need of additional materials such as drywall, insulation, bitumen roofing, and paint.

Carbon Removal for 1 house (1,250 ft²) (116.1 m²)
Applied block: 22.6 kg CO₂×3,000 blocks/house=67,800 kg CO₂ or 67.8 m.t. CO₂ (credits)
Foundation, slab, porch, roof tiles, driveway, and sidewalks: 62.9 m³×1,505 kg/m³×0.001 m.t./kg×32 kg CO₂/m.t./yr×20 yrs=60,585 kg CO₂ or 60.6 m.t. CO₂ (credits)
67.8 m.t. CO₂ (credits)+60.6 m.t. CO₂ (credits)=128.4 m.t. CO₂ (credits)
   Carbon Avoidance for 1 house (1,250 ft²) (116.1 m²)
Applied block: 6.24 kg CO₂×3,000 blocks/house=18,720 kg CO₂ or 18.7 m.t. CO₂ (credits)
Foundation, slab, porch, roof tiles, driveway, and sidewalks: 62.9 m³×405 kg CO₂/m³=25,475 kg CO₂ or 25.5 m.t. CO₂ (credits)
18.7 m.t. CO₂ (credits)+25.5 m.t. CO₂ (credits)=44.2 m.t. CO₂ (credits)
Additional Avoidances from Building Processes=10 credits
   Total Carbon Credit (Removal+Avoidance) 128.4 m.t. CO₂+44.2 m.t. CO₂+10 m.t. CO₂=182.6 m.t. or credits per house

In embodiments of the compositions provided herein, the negative-carbon dioxide emitting cementitious material is a paver. In embodiments, a plurality of pavers cover a surface area of 100,000 m². In embodiments, the pavers are 3 inches thick (0.2286 m). Accordingly, for a surface area of 100,000 m², the pavers contain a volume of 22,860 m³. Referring to the density of the negative-carbon dioxide emitting cementitious material above, 1,505 kg/m³, 22,860 m³ (volume of paver)×1,505 kg/m³ (density)×0.001 m.t./kg affords 34,404 metric tons of material used in pavers.

Carbon Removal for 100,000 m² of pavers

34,404 m.t.×32 kg CO₂/m.t./yr×20 yrs×0.001 m.t./kg=22,018 m.t. of CO₂ (credits)

Carbon Avoidance for 100,000 m² of pavers

22,860 m³×405 kg CO₂/m³=9,258,300 kg or 9,258 m.t. of CO₂ credits

Total Carbon Credit (Avoidance+Removal)=22,018 m.t.+9,258 m.t.=31,276 credits per 100,000 m² of pavers

Although the foregoing embodiments have been described in some detail by way of illustration and Example for purposes of clarity of understanding, one of skill in the art will appreciate that certain changes and modifications may be practiced within the scope of the appended claims. In addition, each reference provided herein is incorporated by reference in its entirety to the same extent as if each reference was individually incorporated by reference. Where a conflict exists between the instant application and a reference provided herein, the instant application shall dominate.

What is claimed is:

1. An artificial, stonelike material set by pouring a cementitious mixture, the poured cementitious mixture comprising:
(a) a natural pozzolan;
(b) a manmade pozzolan;
(c) an aqueous solution;
(d) one or more accelerant; and,
(e) optionally at least one aggregate.

2. The artificial, stonelike material of claim 1, wherein the accelerant comprises one or more nitrate, sulfate, sodium, chloride, and phosphate.

3. The artificial, stonelike material of claim 1 or 2, wherein the at least one aggregate is selected from sand, gravel, lightweight aggregate, crushed stone, and combinations thereof.

4. The artificial, stonelike material of any one of claims 1 to 3, wherein the poured cementitious mixture further comprises an accelerating admixture selected from triethenolamine, calcium formate, silica fume, finely divided silica gel, and calcium chloride.

5. The artificial, stonelike material of any one of claims 1 to 4, wherein the natural pozzolan is selected from rhyolite, obsidian, pitchstone, pumice, basalt, andesite, volcanic ash, sedimentary clay, shale, wollastanite, opaline shale, diatomaceous earth, olivine, and combinations thereof.

6. The artificial, stonelike material of any one of claims 1 to 5, wherein the manmade pozzolan is selected from metakaolin, fly ash, silica fume, ground glass (e.g., ground waste glass), slag (e.g. ground-granulated blast-furnace slag, blast-furnace slag, steel-furnace slag, basic-oxygen-furnace slag, electric-arc-furnace slag, ladle slag, copper slag, steel slag, iron slag, lead slag, nickle slag, zinc slag, aluminum slag, or slag from other metals), burned organic matter residues (e.g., rice husk ash or rice hull ash), expanded clay, expanded shale, calcine clay, and combinations thereof.

7. The artificial, stonelike material of any one of claims 1 to 6, wherein the artificial, stonelike material is set by pouring the cementitious mixture and then applying a curing technique to the poured cementitious mixture.

8. The artificial, stonelike material of any one of claims 1 to 7, wherein the amount of natural pozzolan present relative to the amount of manmade pozzolan ranges from about 33 wt. % to about 300 wt. %.

9. The artificial, stonelike material of any one of claims 1 to 8, wherein the amount of natural pozzolan present relative to the amount of manmade pozzolan ranges from about 50 wt. % to about 200 wt. %.

10. The artificial, stonelike material of any one of claims 1 to 9, wherein the amount of natural pozzolan present relative to the amount of manmade pozzolan ranges from about 85 wt. % to about 115 wt. %.

11. The artificial, stonelike material of any one of claims 1 to 10, wherein the amount of nitrate present relative to the amount of manmade pozzolan ranges from about 2 wt. % to about 30 wt. %.

12. The artificial, stonelike material of any one of claims 1 to 11, wherein the amount of sulfate present relative to the amount of manmade pozzolan ranges from about 0.1 wt. % to about 90 wt. %.

13. The artificial, stonelike material of any one of claims 1 to 12, wherein the amount of sulfate present relative to the amount of manmade pozzolan ranges from about 20 wt. % to about 50% wt. %.

14. The artificial, stonelike material of any one of claims 1 to 13, wherein the amount of chloride present relative to the amount of manmade pozzolan ranges from about 0.1 wt. % to about 12 wt. %.

15. The artificial, stonelike material of any one of claims 1 to 14, wherein the amount of phosphate present relative to the amount of manmade pozzolan ranges from about 0.1 wt. % to about 20 wt. %.

16. The artificial, stonelike material of any one of claims 1 to 15, further comprising MgO and/or Mg(OH)₂.

17. An artificial, stonelike material set by pouring a cementitious mixture, the poured cementitious mixture comprising:
(a) a pozzolan;
(b) MgO;
(c) an aqueous solution;
(d) one or more accelerant; and,
(e) optionally at least one aggregate.

18. The artificial, stonelike material of claim 17 wherein the accelerant comprises one or more nitrate, sulfate, sodium, chloride, and phosphate.

19. The artificial, stonelike material of claim 17 or 18, wherein the at least one aggregate is selected from sand, gravel, lightweight aggregate, crushed stone, and combinations thereof.

20. The artificial, stonelike material of any one of claims 17 to 19, wherein the poured cementitious mixture further comprises an accelerating admixture selected from triethenolamine, calcium formate, silica fume, finely divided silica gel, and calcium chloride.

21. The artificial, stonelike material of any one of claims 17 to 20, wherein the pozzolan is selected from a manmade pozzolan, a natural pozzolin, and combinations thereof.

22. The artificial, stonelike material of any one of claims 17 to 21, wherein the artificial, stonelike material is set by pouring the cementitious mixture and then applying a curing technique to the poured cementitious mixture.

23. The artificial, stonelike material of any one of claims 17 to 22, wherein the amount of pozzolan present relative to the amount of MgO ranges from about 33 wt. % to about 300 wt. %.

24. The artificial, stonelike material of any one of claims 17 to 23, wherein the amount of pozzolan present relative to the amount of MgO from about 50 wt. % to about 200 wt. %.

25. The artificial, stonelike material of any one of claims 17 to 24, wherein the amount of pozzolan present relative to the amount of MgO from about 85 wt. % to about 115 wt. %.

26. The artificial, stonelike material of any one of claims 17 to 25, wherein the amount of nitrate present relative to the amount of pozzolan ranges from about 2 wt. % to about 30 wt. %.

27. The artificial, stonelike material of any one of claims 17 to 26, wherein the amount of sulfate present relative to the amount of pozzolan from about 0.1 wt. % to about 90 wt. %.

28. The artificial, stonelike material of any one of claims 17 to 27, wherein the amount of sulfate present relative to the amount of pozzolan from about 20 wt. % to about 50% wt. %.

29. The artificial, stonelike material of any one of claims 17 to 28, wherein the amount of chloride present relative to the amount of pozzolan from about 0.1 wt. % to about 12 wt. %.

30. The artificial, stonelike material of any one of claims 17 to 29, wherein the amount of phosphate present relative to the amount of pozzolan ranges from about 0.1 wt. % to about 20 wt. %.

31. An artificial, stonelike material set by pouring a cementitious mixture, the poured cementitious mixture comprising:
(a) a pozzolan;
(b) Mg(OH)₂;
(c) an aqueous solution;
(d) one or more accelerant; and,
(e) optionally at least one aggregate.

32. The artificial, stonelike material of claim 31, wherein the accelerant comprises one or more nitrate, sulfate, sodium, chloride, and phosphate.

33. The artificial, stonelike material of claim 31 or 32, wherein the at least one aggregate is selected from sand, gravel, lightweight aggregate, crushed stone, and combinations thereof.

34. The artificial, stonelike material of any one of claims 31 to 33, wherein the poured cementitious mixture further comprises an accelerating admixture selected from triethenolamine, calcium formate, silica fume, finely divided silica gel, and calcium chloride.

35. The artificial, stonelike material of any one of claims 31 to 34, wherein the pozzolan is selected from a manmade pozzolan, a natural pozzolin, and combinations thereof.

36. The artificial, stonelike material of any one of claims 31 to 35, wherein the artificial, stonelike material is set by pouring the cementitious mixture and then applying a curing technique to the poured cementitious mixture.

37. The artificial, stonelike material of any one of claims 31 to 36, wherein the amount of pozzolan present relative to the amount of Mg(OH)₂ ranges from about 33 wt. % to about 300 wt. %.

38. The artificial, stonelike material of any one of claims 31 to 37, wherein the amount of pozzolan present relative to the amount of Mg(OH)₂ from about 50 wt. % to about 200 wt. %.

39. The artificial, stonelike material of any one of claims 31 to 38, wherein the amount of pozzolan present relative to the amount of Mg(OH)₂ from about 85 wt. % to about 115 wt. %.

40. The artificial, stonelike material of any one of claims 31 to 39, wherein the amount of nitrate present relative to the amount of pozzolan ranges from about 2 wt. % to about 30 wt. %.

41. The artificial, stonelike material of any one of claims 31 to 40, wherein the amount of sulfate present relative to the amount of pozzolan from about 0.1 wt. % to about 90 wt. %.

42. The artificial, stonelike material of any one of claims 31 to 41, wherein the amount of sulfate present relative to the amount of pozzolan from about 20 wt. % to about 50% wt. %.

43. The artificial, stonelike material of any one of claims 31 to 42, wherein the amount of chloride present relative to the amount of pozzolan from about 0.1 wt. % to about 12 wt. %.

44. The artificial, stonelike material of any one of claims 31 to 43, wherein the amount of phosphate present relative to the amount of pozzolan ranges from about 0.1 wt. % to about 20 wt. %.

45. An artificial, stonelike material set by pouring a cementitious mixture, the poured cementitious mixture comprising:
(a) a natural pozzolan;
(b) ground-granulated blast-furnace slag; and
(c) an aqueous solution comprising one or more accelerant.

46. The artificial, stonelike material of claim 45, wherein the accelerant comprises one or more nitrate, sulfate, sodium, chloride, and phosphate.

47. The artificial, stonelike material of claim 45 or 46, wherein the poured cementitious mixture further comprises at least one aggregate.

48. The artificial, stonelike material of claim 47, wherein the at least one aggregate is selected from sand, gravel, lightweight aggregate, crushed stone, and combinations thereof.

49. The artificial, stonelike material of any one of claims 45 to 48, wherein the the poured cementitious mixture further comprises an accelerating admixture selected from triethenolamine, calcium formate, silica fume, finely divided silica gel, and calcium chloride.

50. The artificial, stonelike material of any one of claims 45 to 49, wherein the natural pozzolan is selected from rhyolite, obsidian, pitchstone, pumice, basalt, andesite, volcanic ash, sedimentary clay, sedimentary shale, calcined clay, rice husk ash, diatomaceous earth, metakaolin, olivine, and combinations thereof.

51. The artificial, stonelike material of any one of claims 45 to 50, wherein the natural pozzolan is basalt.

52. An artificial, stonelike material set by pouring a cementitious mixture, the poured cementitious mixture comprising:
(a) a natural pozzolan;
(b) ground-granulated blast-furnace slag;
(c) an aqueous solution comprising one or more accelerant; and,
(d) at least one aggregate.

53. The artificial, stonelike material of claim 52, wherein the accelerant comprises one or more nitrate, sulfate, sodium, chloride, and phosphate.

54. The artificial, stonelike material of claim 52 or 53, wherein the at least one aggregate is selected from sand, gravel, lightweight aggregate, crushed stone, and combinations thereof.

55. The artificial, stonelike material of any one of claims 52 to 54, wherein the natural pozzolan is selected from rhyolite, obsidian, pitchstone, pumice, basalt, andesite, volcanic ash, sedimentary clays and shales, calcined clays, rice husk ash, diatomaceous earth, metakaolin, olivine, and combinations thereof.

56. The artificial, stonelike material of any one of claims 52 to 55, wherein the natural pozzolan is basalt.

57. The artificial, stonelike material of any one of claims 45 to 56, wherein the artificial, stonelike material is set by pouring the cementitious mixture and then applying a curing technique to the poured cementitious mixture.

58. The artificial, stonelike material of any one of claims 45 to 57, wherein the at least one aggregate is selected from sand, gravel, lightweight aggregate, crushed stone, and combinations thereof.

59. The artificial, stonelike material of any one of claims 45 to 58, wherein the amount of natural pozzolan present relative to the amount of ground-granulated blast-furnace slag ranges from about 33 wt. % to about 300 wt. %.

60. The artificial, stonelike material of any one of claims 45 to 59, wherein the amount of natural pozzolan present relative to the amount of ground-granulated blast-furnace slag from about 50 wt. % to about 200 wt. %.

61. The artificial, stonelike material of any one of claims 45 to 60, wherein the amount of natural pozzolan present relative to the amount of ground-granulated blast-furnace slag from about 85 wt. % to about 115 wt. %.

62. The artificial, stonelike material of any one of claims 45 to 61, wherein the amount of nitrate present relative to the amount of ground-granulated blast-furnace slag ranges from about 2 wt. % to about 30 wt. %.

63. The artificial, stonelike material of any one of claims 45 to 62, wherein the amount of sulfate present relative to the amount of ground-granulated blast-furnace slag from about 0.1 wt. % to about 90 wt. %.

64. The artificial, stonelike material of any one of claims 45 to 63, wherein the amount of sulfate present relative to the amount of ground-granulated blast-furnace slag from about 20 wt. % to about 50% wt. %.

65. The artificial, stonelike material of any one of claims 45 to 64, wherein the amount of chloride present relative to the amount of ground-granulated blast-furnace slag from about 0.1 wt. % to about 12 wt. %.

66. The artificial, stonelike material of any one of claims 45 to 65, wherein the amount of phosphate present relative to the amount of ground-granulated blast-furnace slag ranges from about 0.1 wt. % to about 20 wt. %.

67. The artificial, stonelike material of any one of claims 45 to 66, wherein the poured cementitious mixture further comprises MgO and/or Mg(OH)₂.

68. The artificial, stonelike material of any one of claims 45 to 67, wherein the poured cementitious mixture further comprises CaO.

69. An artificial, stonelike material formed from a poured cementitious mixture and configured to absorb and retain carbon dioxide, the poured cementitious mixture comprising:
(a) a natural pozzolan;
(b) ground-granulated blast-furnace slag;
(c) an aqueous solution comprising one or more accelerant; and,
(d) optionally at least one aggregate.

70. The artificial, stonelike material of claim 69, wherein the poured cementitious mixture absorbs and retains carbon dioxide over a period of time as it is cured and hardened.

71. The artificial, stonelike material of claim 69 or 70, wherein the accelerant comprises one or more nitrate, sulfate, sodium, chloride, and phosphate.

72. The artificial, stonelike material of any one of claims 69 to 71, wherein the at least one aggregate is selected from sand, gravel, lightweight aggregate, crushed stone, and combinations thereof.

73. The artificial, stonelike material of claim any one of claims 69 to 72, wherein the natural pozzolan is selected from rhyolite, obsidian, pitchstone, pumice, basalt, andesite, volcanic ash, sedimentary clays and shales, calcined clays, rice husk ash, diatomaceous earth, metakaolin, olivine, and combinations thereof.

74. The artificial, stonelike material of any one of claims 69 to 73, wherein the natural pozzolan is basalt.

75. The artificial, stonelike material of any one of claims 69 to 74, wherein the amount of natural pozzolan present relative to the amount of ground-granulated blast-furnace slag ranges from about 33 wt. % to about 300 wt. %.

76. The artificial, stonelike material of any one of claims 69 to 75, wherein the amount of natural pozzolan present relative to the amount of ground-granulated blast furnace slag ranges from about 50 wt. % to about 200 wt. %.

77. The artificial, stonelike material of any one of claims 69 to 76, wherein the amount of natural pozzolan present relative to the amount of ground-granulated blast-furnace slag from about 85 wt. % to about 115 wt. %.

78. The artificial, stonelike material of any one of claims 69 to 77, wherein the amount of nitrate present relative to the amount of ground-granulated blast-furnace ranges from about 2 wt. % to about 30 wt. %.

79. The artificial, stonelike material of any one of claims 69 to 77, wherein the amount of sulfate present relative to the amount of ground-granulated blast-furnace ranges from about 0.1 wt. % to about 90 wt. %.

80. The artificial, stonelike material of any one of claims 69 to 77, wherein the amount of sulfate present relative to the amount of ground-granulated blast-furnace slag ranges from about 20 wt. % to about 50 wt. %.

81. The artificial, stonelike material of any one of claims 69 to 77, wherein the amount of chloride present relative to the amount of ground-granulated blast-furnace slag ranges from about 0.1 wt. % to about 12 wt. %.

82. The artificial, stonelike material of any one of claims 69 to 77, wherein the amount of phosphate present relative to the amount of ground-granulated blast-furnace slag ranges from about 0.1 wt. % to about 20 wt. %.

83. The artificial, stonelike material of any one of claims 69 to 82, wherein the poured concrete mixture absorbs and retains carbon dioxide of at least 5 weight % of the artificial, stonelike material over a 15-year period.

84. A manufacturing process of a negative carbon dioxide-emitting artificial, stonelike material comprising:
(a) mixing a natural pozzolan in an aqueous solution comprising one or more accelerant, with ground-granulated blast-furnace slag to form a cementitious mixture;
(b) pouring the cementitious mixture into a structural component mold to form a poured cementitious mixture; and then,
(c) curing the cementitious concrete mixture from step (b) in the structural mold to form a negative carbon dioxide-emitting artificial, stonelike material.

85. The manufacturing process of claim 84 further comprising adding a water repellent silane or oil repellent silane to the cementitious mixture of step (a).

86. The manufacturing process of claim 84 or 85, wherein the amount of natural pozzolan present relative to the amount of ground-granulated blast-furnace slag from about 33 wt. % to about 300 wt. %.

87. The manufacturing process of any one of claims 84 to 86, wherein the amount of natural pozzolan present relative to the amount of ground-granulated blast-furnace slag from about 50 wt. % to about 200 wt. %.

88. The manufacturing process of any one of claims 84 to 87, wherein the amount of natural pozzolan present relative to the amount of ground-granulated blast-furnace slag from about 85 wt. % to about 115 wt. %.

89. The manufacturing process of any one of claims 84 to 88, wherein the amount of nitrate present relative to the amount of ground-granulated blast-furnace slag ranges from about 2 wt. % to about 30 wt. %.

90. The manufacturing process of any one of claims 84 to 89, wherein the amount of sulfate present relative to the amount of ground-granulated blast-furnace slag ranges from about 0.1 wt. % to about 90 wt. %.

91. The manufacturing process of any one of claims 84 to 90, wherein the amount of sulfate present relative to the amount of ground-granulated blast-furnace slag ranges from about 20 wt. % to about 50 wt. %.

92. The manufacturing process of any one of claims 84 to 91, wherein the amount of chloride present relative to the amount of ground-granulated blast-furnace slag ranges from about 0.1 wt. % to about 12 wt. %.

93. The manufacturing process of any one of claims 84 to 92, wherein the amount of phosphate present relative to the amount of ground-granulated blast-furnace slag ranges from about 0.1 wt. % to about 20 wt. %.

94. A method for reducing carbon emissions comprising:
(a) mixing natural pozzolan, a man-made pozzolan, an aqueous solution and one or more accelerant to form a cementitious mixture;
(b) pouring the cementitious mixture to form a poured cementitious mixture;
(c) curing the poured cementitious mixture from step (b) to form a negative-carbon dioxide emitting cementitious material;
thereby forming a negative-carbon dioxide emitting cementitious material that absorbs and prevents the emission of carbon dioxide.

95. The method of claim 94, wherein the reduction of carbon emissions consists of the amount of carbon dioxide absorbed and the amount of prevented carbon dioxide emission.

96. The method of claim 94, wherein the negative-carbon dioxide emitting cementitious material is a cementitious masonry unit.

97. The method of claim 96, wherein the cementitious masonry unit absorbs 11.2 kg of CO₂ over a 20 year period and that the emission of 3.08 kg of CO₂ per cementitious masonry unit.

98. The method of claim 97, wherein a plurality of cementitious masonry units are combined with a filling or mortar material to form a house structure having a square footage of at least 1,250 ft².

99. The method of claim 98, wherein the house structure absorbs at least 120 metric tons of CO₂ and prevents the emission of at least 40 metric tons of CO₂.

100. The method of claim 94, wherein the negative-carbon dioxide emitting cementitious material is a paver.

101. The method of claim 100, wherein a plurality of pavers has a surface area of 100,000 m².

102. The method of claim 101, wherein the plurality of pavers absorbs at least 20,000 m.t. of CO₂ and prevents the emission of at least 9,000 m.t. of CO₂.

103. The method of any one of claims 94 to 102, wherein the negative-carbon dioxide emitting cementitious material comprises the artificial, stonelike material of any one of claims 1 to 83, or manufactured by the process of any one of claims 84 to 93.

104. An artificial, stonelike material set by pouring a cementitious mixture, the poured cementitious mixture comprising:
(a) a natural pozzolan;
(b) ground-granulated blast-furnace slag; and
(c) an aqueous solution; and,
(d) one or more accelerant.

105. The artificial, stonelike material of claim 104, wherein the accelerant comprises one or more nitrate, sulfate, sodium, chloride, and phosphate.

106. The artificial, stonelike material of claim 104 or 105, wherein the poured cementitious mixture further comprises at least one aggregate.

107. The artificial, stonelike material of claim 106, wherein the at least one aggregate is selected from sand, gravel, lightweight aggregate, crushed stone, and combinations thereof.

108. The artificial, stonelike material of any one of claims 104 to 107, wherein the poured cementitious mixture further comprises an accelerating admixture selected from triethenolamine, calcium formate, silica fume, finely divided silica gel, and calcium chloride.

109. The artificial, stonelike material of any one of claims 104 to 108, wherein the natural pozzolan is selected from rhyolite, obsidian, pitchstone, pumice, basalt, andesite, volcanic ash, sedimentary clay, sedimentary shale, calcined clay, rice husk ash, diatomaceous earth, metakaolin, olivine, and combinations thereof.

110. The artificial, stonelike material of any one of claims 104 to 109, wherein the natural pozzolan is basalt.
